(19) United States
(12) Patent Application Publication
(10) Pub. No.: US 2012/0056000 A1
(43) Pub. Date: Mar. 8, 2012

(54) MEDICATION MANAGEMENT SYSTEM

(75) Inventor: TRISTAN SAMIR SHORES, ALOHA, OR (US)

(73) Assignee: TRISTAN SAMIR SHORES, ALOHA, OR (US)

(21) Appl. No.: 13/226,093

(22) Filed: Sep. 6, 2011

Related U.S. Application Data
(60) Provisional application No. 61/380,203, filed on Sep. 4, 2010.
(60) Provisional application No. 61/507,599, filed on Jul. 14, 2011.
(60) Provisional application No. 61/528,762, filed on Aug. 30, 2011.

(51) Int. Cl. G06K 19/077

(52) U.S. Cl. 235/492

(57) ABSTRACT

A medication management system that is easy to use, scalable, highly versatile, and promotes the safe administration of medication. Furthermore, the medication management system is portable and adapted for either standalone or networked operation.

### CROSS-REFERENCE TO RELATED APPLICATIONS

This application claims the benefit of U.S. Provisional Application Nos. 61380203, 61507599, and 61528762, respectively filed on Sep. 4, 2010, Jul. 14, 2011, and Aug. 30, 2011 by the present inventor, which are incorporated herein by reference.

### TECHNICAL FIELD

Disclosed embodiments relate to medication compliance, and more particularly, to systems, methods, and devices for the administration of medication.

### SUMMARY

Disclosed embodiments include an electronically identifiable medication bottle, comprising: (a) a medication container; and (b) circuitry adapted for receipt and storage of power, transmission of identifying information, receipt of a medication schedule, and issuance of medication alerts, the circuitry includes a processor, a memory, a rechargeable power storage device, at least one audio or visual device, at least one network interface, and a user-interface, whereby the circuitry can facilitate identification and administration of the contents of the medication container.

Disclosed embodiments further include an electronically identifiable medication bottle, comprising: (a) a medication container; and (b) circuitry adapted for receipt and storage of power, transmission of identifying information, receipt of a medication schedule, and issuance of medication alerts, the circuitry includes a processor, a memory, a rechargeable power storage device, at least one audio or visual device, a USB interface, and a user-interface, whereby the circuitry can facilitate identification and administration of the contents of the medication container.

Disclosed embodiments further include an electronically identifiable adapter, comprising: (a) an adapter for removable attachment to a medication container, the adapter including a base for seating a bottom portion of a medication container and a raised back for supporting a sidewall portion of a medication container; and (b) circuitry adapted for receipt and storage of power, transmission of identifying information, receipt of a medication schedule, and issuance of medication alerts, the circuitry includes a processor, a memory, a rechargeable power storage device, at least one audio or visual device, at least one network interface, and a user-interface, whereby the circuitry can facilitate identification and administration of the contents of an attached medication container and a fastening mechanism can be used to removably attach a medication container to the electronically identifiable adapter.

### BRIEF DESCRIPTION OF THE DRAWINGS

Disclosed embodiments are illustrated by way of example, and not by way of limitation, in the figures of the accompanying drawings.

FIGS. 1A, 2A, 3A, 4A, 4D, 4E, 5A, 6A, 7A, 8A, 9A, 10A, 10D, 11A, 12A, 12B, 12C, 13A, 13B, 14A, & 14B are perspective views of tracked medication unit embodiments.

FIGS. 1B, 2B, 3B, 4B, 5B, 6B, 7B, 8B, 9B, 10B, 10C, & 11B are side sectional views of tracked medication unit embodiments.

FIGS. 1C, 2C, 3C, 4C, 5C, 7C, 8C, & 9C are top sectional views of tracked medication unit embodiments.

FIGS. 4A, 4B, 4C, 4D, 4E, 14A, & 14B are views of tracked medication adapter embodiments.

FIGS. 15A, 16A, 17A, 18A, 19A, & 20 are perspective views of base unit, base unit extension, and tracked medication unit embodiments.

FIGS. 15B, 16B, 17B, 18B, & 19B are bottom sectional views of base unit and base unit extension embodiments.

FIGS. 21 & 22 are perspective views of base unit and tracked medication unit embodiments.

FIGS. 23 & 24 are block diagrams of web-accessible medication management system embodiments.

FIG. 25 is a block diagram of a thin-client medication management system embodiment.

FIG. 26 is a perspective view of an embodiment of the alert-extension.

FIG. 27 is a block diagram of a network server embodiment.

FIGS. 28A & 28B are flow diagrams representing operations of thin-client base unit embodiments.

FIGS. 29A & 29B are flow diagrams representing operations of network server embodiments.

FIGS. 30A, 30B, & 30C are flow diagrams representing operations of coordinator embodiments.

FIG. 31 is a block diagram representing the architecture of tracking module embodiments.

FIG. 32 is a block diagram representing the architecture of base unit embodiments.

FIG. 33 is a block diagram representing the architecture of base unit extension embodiments.

FIG. 34 is a block diagram representing the architecture of alert-extension embodiments.

FIG. 35 is a block diagram representing the architecture of a coordinator embodiment.

### DETAILED DESCRIPTION

### A. Definitions & Conventions

### A.1 WAN Networks

WAN networks may include any suitable technology, such as: Evolution-Data Optimized (EV-DO), Code Division Multiple Access (CDMA), High Speed Packet Access (HSPA), High Speed Downlink Packet Access (HSDPA), High Speed Uplink Packet Access (HSUPA), General Packet Radio Service (GPRS), Global System for Mobile Communications (GSM), Time Division Multiple Access (TDMA), Enhance Data Rate for GSM Evolution (EDGE), Universal Mobile Telecommunications System (UMTS), Circuit Switched Data (CSD), Worldwide Interoperability for Microwave Access (WiMAX), and/or WiFi.

The Internet includes any technology or infrastructure for Internet communications. Cellular communications include transmission via a cellular modem or via a remote cellular-IP gateway.

### A.2 Computing Device

Computing devices 120 include a desktop personal computer (PC), laptop PC, tablet PC, handheld computer, or mobile communication device 130.

### A.3 Mobile Communication Device

Mobile communication devices 130 may include: a PDA, mobile phone, smartphone, pager, messaging phone, and so forth. Mobile communication devices 130 are capable of receiving at least one communication such as: Short Message Service (SMS), Multimedia Message Service (MMS), email, instant message, page, or phone call.

### A.4 Conventions

A numeral with hyphenated subscripts refers to a range of numerals (e.g. 300a-c refers to 300a, 300b, and 300c).

A numeral with concatenated subscripts refers to specific numerals (e.g. 300ac refers to 300a & 300c).

A numeral with no subscripts refers to all subscripts (if any).

### B. System Component Description and Operation

### B.1 Medication Container

The medication container 400, which includes a lid 416a-c, is intended for storage of a medication or medical device.

### B.2 Tracking Module

A tracking module associated with a medication container 400 can electronically identify the contents of the medication container 400.

A tracking module includes all components that are required for a tracking module's functionality. Examples of these components (not all are used in each tracking module embodiment): PCB circuitry 352, flex circuitry 350, power receiver coil 328, communication coil(s) 334/336, speaker 360, numeric display 314, network interface(s) 524, battery 356, tactile switch 316, magnet 342, shielding 338, housing 310, connector(s) 318/326, and electrical contacts 324.

### B.2.1 Tracking Modules in First-Eleventh Tracked Medication Unit Embodiments

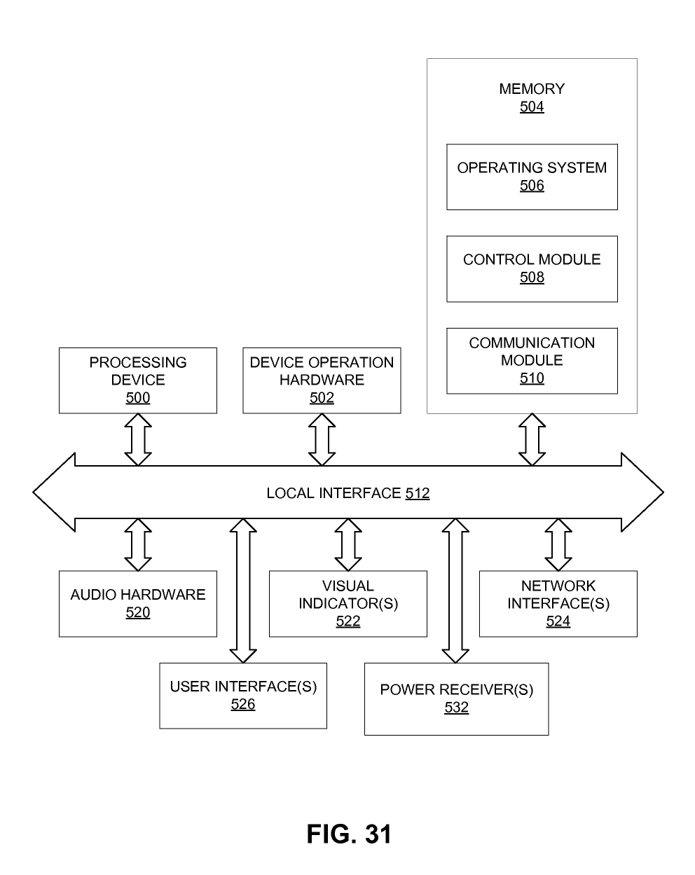

The tracking modules in tracked medication unit embodiments 300 have the architecture shown in FIG. 31.

The processing device 500 is adapted to execute commands stored in memory 504 and comprises a general-purpose processor, a micro-processor, one or more application specific integrated circuits (ASICs), a plurality of suitably configured digital logic gates, and other known electrical configurations comprising discrete elements both individually and in various combinations to coordinate the overall operation of a tracking module.

The device operation hardware 502 comprises the various components used for the operation of a tracking module, including a lithium-ion battery, power regulation circuitry, and real-time clock. The local interface 512 comprises the electrical interconnections between the components of a tracking module.

The memory 504 includes an operating system 506, control module 508, and communication module 510. The operating system 506 contains the various commands used to control the general operation of a tracking module. The communication module 510 comprises software or firmware that is adapted, in conjunction with the network interface 524 device, to facilitate external communications. The control module 508 comprises the software/firmware which controls the operation of a tracking module.

The audio hardware 520 comprises the basic components necessary to generate sounds using a speaker 360. The speaker 360 is used to generate alert tones, event tones (e.g. low battery alert), and voice synthesized messages (e.g. medication usage information). The visual indicator 522 comprises an LED numeric display 314 used to signal an alert and to convey dosage quantity.

Power receiver 532 circuitry facilitates receipt of power from a base unit 200 or power charger 150, and a charging circuit on the tracking module manages recharge of the internal lithium-ion battery.

A user interface 526 permits a user to cancel an alert (directly or indirectly) generated by a tracking module. Direct methods include use of a button, touch sensitive surface, voice recognition, or tap/shake/tilt sensor. Indirect methods include an automatic timeout setting predetermined by a user.

The general operation of the tracking module includes: (a) storing a unique ID, (b) communicating with a base unit 200, (c) storing one or more medication schedules with alert options, (d) emitting medication alerts, and (e) logging of event data. Event data includes the time that a medication alert was acknowledged by a user.

When a tracked medication unit 300 is docked to a base unit 200, medication information stored in the memory 504 of the tracking module can be updated by a base unit 200. Upon disconnection from a base unit 200, the tracking module becomes an independent medication reminder device that is capable of providing medication alerts according to the medication information stored in its memory 504.

Disclosures relating to the interaction of a tracking module with a base unit 200 equivalently apply to the interaction of a tracking module with a compatible base extension unit 280.

### B.2.2 Tracking Module in Twelfth Tracked Medication Unit Embodiment

This embodiment of a tracking module is solely an unpowered (passive) NFC transponder with NFC antenna (i.e. NFC tag).

### B.3 Tracked Medication Unit

A tracked medication unit 300 includes a medication container 400 and a tracking module.

The tracking module and its components can be arranged or distributed in any manner with respect to the medication container 400, including: (a) the medication container 400 is partially or wholly within the tracking module, (b) the tracking module is partially or wholly within the medication container 400, (c) components of the tracking module are embedded within the medication container 400, including within the lid, base, and/or sides, (d) the tracking module is autonomous from the medication container 400 and is removably or non-removably attached to the medication container 400, (e) the tracking module and the medication container 400 are sections within a single part.

### B.3.1 First Tracked Medication Unit Embodiment

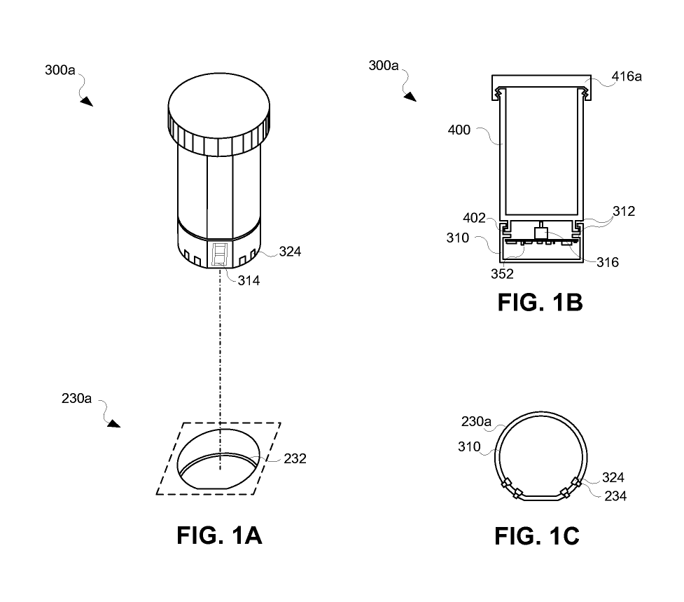

This embodiment of a tracked medication unit 300a has the physical configuration shown in FIGS. 1A, 1B, 1C, & 15A.

The medication container 400 and housing 310 are plastic components. The electrical contacts 324 are molded in the sidewall of the housing 310 in order to maintain a sealed tracking module.

The outer foot 402 is retained between the retaining flanges 312 of the housing 310. The distance between the retaining flanges 312 is sufficient to allow the medication container 400 to travel vertically by approximately 2 mm. A tactile switch 316 is mounted directly below the medication container 400, such that a user's push that causes a downward movement of the medication container 400 will actuate the tactile switch 316. Upon release of the medication container 400, the tactile switch 316 will snap back and push the medication container 400 back up. This mechanism serves as a user-interface for cancelling an alert generated by the tracking module.

A thin 7-segment LED numeric display 314 is located on the front side of the tracked medication unit 300a.

When the tracked medication unit 300a is seated in a base unit well 230a, four electrical contacts 324 of the tracking module respectively engage four spring-loaded electrical contacts 234 in the base unit well 230a. Two electrical contacts 324 are for power and ground transmission, and the remaining two are for RS232 receive/transmit signals. In this way, the internal battery in the tracking module can be charged, and bidirectional full-duplex communications between the tracking module and the base unit well 230a can occur. The link layer of this network interface 524 is implemented by a UART.

Power is continuously supplied to the power/ground contacts. Even a tracking module with a fully discharged battery will be able to communicate with a base unit well 230a once the tracked medication unit 300a is docked. Monitoring of the RS232 receive line allows the base unit 200a to detect the docking/undocking of a tracked medication unit 300a.

### B.3.2 Second Tracked Medication Unit Embodiment

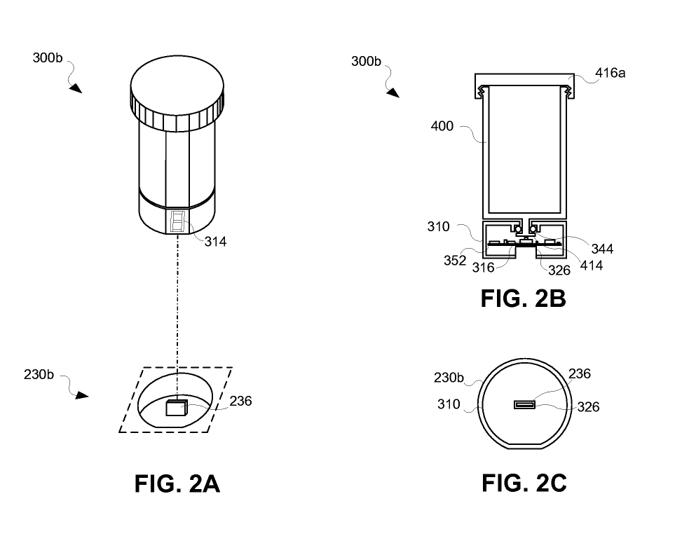

This embodiment of a tracked medication unit 300b has the physical configuration shown in FIGS. 2A, 2B, & 2C.

The medication container 400 and housing 310 are plastic components.

A center foot 414 of the medication container 400 is retained within the housing 310. A rubber O-ring 344 encircling the center foot 414 maintains a sealed tracking module. There is sufficient play in the retaining mechanism to allow the medication container 400 to travel vertically by approximately 2 mm. A tactile switch 316 is mounted directly below the center foot 414. A user's push that causes a downward movement of the medication container 400 will actuate the tactile switch 316. This mechanism serves as a user-interface for cancelling an alert generated by the tracking module.

A thin 7-segment LED numeric display 314 is embedded on the front side of the tracked medication unit.

When the tracked medication unit 300b is seated in a base unit well 230b, the connector plug 236 of the base unit well 230b is seated in the connector receptacle 326 of the tracking module. The connector plug 236 and connector receptacle 326 each have four internal electrical contacts, two of which are for power and ground transmission, and the remaining two for USB data signals. In this way, the internal battery in the tracking module can be charged, and bidirectional half-duplex communications between the tracking module and a base unit well 230b can occur. The link layer of this network interface 524 is implemented by a USB controller.

USB power is continuously present at the power/ground contacts of the base unit well 230b. Even a tracking module with a fully discharged battery will be able to communicate with a base unit well 230b once the tracked medication unit 300b is docked. The USB controller for a base unit well 230b automatically detects the docking/undocking of a tracked medication unit 300b.

### B.3.3 Third Tracked Medication Unit Embodiment

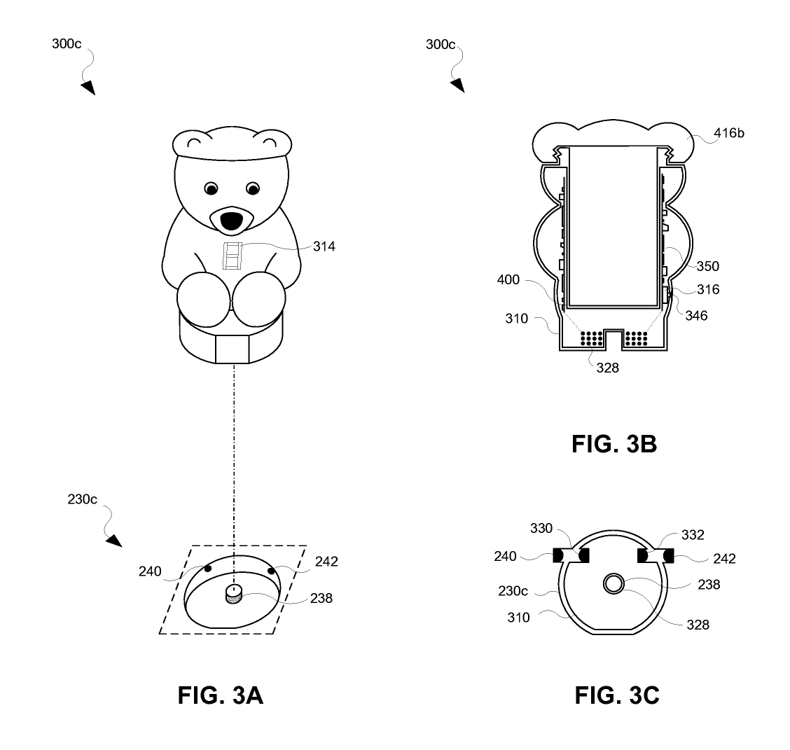

This embodiment of the tracked medication unit 300c has the physical configuration shown in FIGS. 3A & 3B.

The medication container 400 and housing 310 are plastic components in a child-friendly form. The cavity between their respective sidewalls houses flex circuitry 350, which can conform to the shape of the medication container 400.

A tactile switch 316 with a sealed button cover 346 provides a user-interface for cancellation of an alert issuing from the tracking module.

A thin 7-segment LED numeric display 314 is located on the front side of the tracked medication unit 300c.

When the tracked medication unit 300c is seated in a base unit well 230c, the power transmitter coil 238 (embedded in a protrusion of the base unit well 230c) is situated within the power receiver coil 328 of the tracking module. Inductive coupling of the power transmitter coil 238 and power receiver coil 328 allows power transfer from a base unit well 230c to the tracking module. In this way, the internal battery of the tracking module can be charged.

When the tracked medication unit 300c is seated in a base unit well 230c, the photodiode emitter 240 and photodiode receiver 242 of the base unit well 230c respectively align with the photodiode receiver 330 and photodiode emitter 332 of the tracking module. Consequently, bidirectional full-duplex IrDA communications between a base unit well 230c and the tracking module can occur. The link layer of this network interface 524 is implemented by a UART.

The photodiode emitter 240 and photodiode receiver 242 of the base unit well 230c align and thus the docking/undocking of a tracked medication unit 300c can be detected. Upon insertion, power transfer to the tracking module is initiated. Even a tracking module with a fully discharged battery will be able to communicate with a base unit well 230c once power transfer is initiated.

In order to prevent magnetic-coupling with an object other than a tracking module, the power transmitter coil 238 is deactivated if prompt communication with a tracking module is not established or if periodic communication attempts fail.

### B.3.4 Fourth Tracked Medication Unit Embodiment

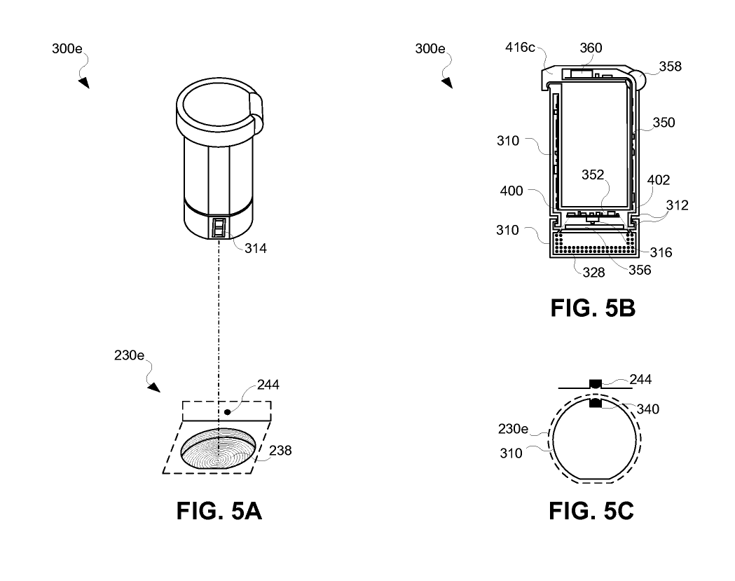

This embodiment of a tracked medication unit 300e has the physical configuration shown in FIGS. 5A, 5B, 5C, & 16A.

The medication container 400 and housing 310 are plastic components. The cavity between their respective sidewalls houses flex circuitry 350, which can conform to the shape of the medication container 400. The cavity within the lid 416c, which is attached to the medication container by a hinge 358, houses audio circuitry, such as a piezoelectric speaker 360.

A tactile switch 316 is located below the medication container 400, such that a user's push that causes a downward movement of the medication container 400 will actuate the tactile switch 316. This mechanism provides a user-interface for cancellation of an alert generated by the tracking module.

A thin 7-segment LED numeric display 314 is located on the front side of the tracked medication unit.

When the tracked medication unit 300e is seated in a base unit well 230e, the power transmitter coil 238 (embedded in the base and sidewall of the base unit well 230e) is in close proximity to the power receiver coil 328 of the tracking module. Inductive coupling of the power transmitter coil 238 and power receiver coil 328 allows power transfer from a base unit well 230e to the tracking module. In this way, the internal battery 356 of the tracking module can be charged.

When the tracked medication unit 300e is seated in a base unit well 230e, an LED 244 near the base unit well 230e aligns with an LED 340 in the sidewall of the tracked medication unit 300e. Since at close range, an LED can act as a photodiode emitter or photodiode receiver, bidirectional half-duplex IrDA communications between a base unit well 230e and a tracking module can occur. The link layer of this network interface 524 is implemented by a UART.

The power transmitter coil 238 in a base unit well 230e is continuously operated as an inductive proximity sensor in order for a base unit well 230e to detect the docking/undocking of a tracked medication unit 300e. Upon insertion, power transfer to the tracking module is initiated. Even a tracking module with a fully discharged battery 356 will be able to communicate with a base unit well 230e once power transfer is initiated.

In order to prevent magnetic-coupling with an object other than a tracking module, the power transmitter coil 238 is deactivated if prompt communication with a tracking module is not established or if periodic communication attempts fail.

### B.3.5 Fifth Tracked Medication Unit Embodiment

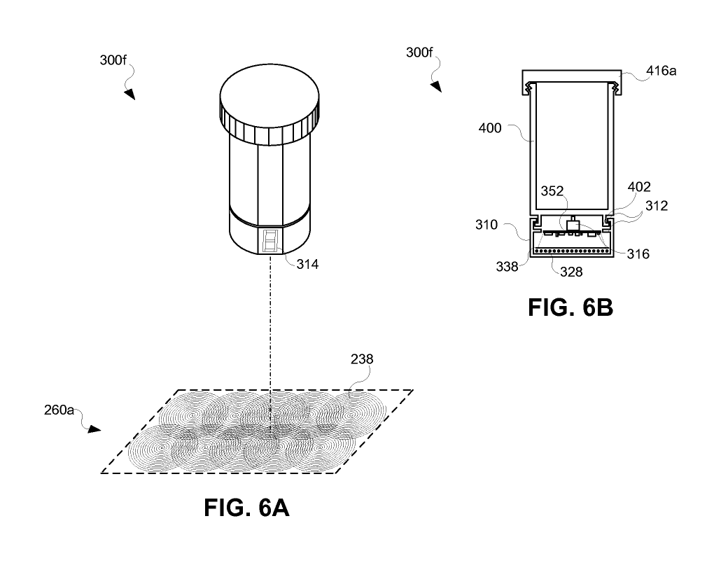

This embodiment of a tracked medication unit 300f has the physical configuration shown in FIGS. 6A, 6B, & 17A.

The medication container 400 and housing 310 are plastic components.

A tactile switch 316 is located below the medication container 400, such that a user's push that causes a downward movement of the medication container 400 will actuate the tactile switch 316. This mechanism provides a user-interface for cancellation of an alert generated by the tracking module.

A thin layer of ferrite and copper shielding 338 between the power receiver coil 328 and the remainder of the internal circuitry of the tracking module, shields the remaining circuitry of the tracking module from excessive electromagnetic noise.

Embedded within the base unit surface 260a is an two dimensional array of power transmitter coils 238 such that one of the coils is always within close proximity to the power receiver coil 328 of a tracking module seated anywhere on the base unit surface 260a. The base unit surface 260a continuously operates power transmitter coils 238 as inductive proximity sensors in order to detect the presence of a tracking module. When a tracking module is detected, the coils are sequentially activated and attempt communication with the detected tracking module. Upon initiation of communication with the base unit surface 260a, a tracking module reports the signal strength measured at its power receiver coil 328. The power transmitter coil 238 that generates the highest signal strength in the tracking module is used to transfer power to and communicate with the tracking module. This procedure is periodically repeated to ensure optimal inductive-coupling. In this way, the internal battery 356 of the tracking module can be charged.

Communication from a base unit surface 260a to the tracking module occurs by amplitude key shifting of the power signal transmitted by the power transmitter coil 238, which results in detectable high/low voltages induced across the power receiver coil 328. Communication from the tracking module to a base unit surface 260a occurs by load key shifting downstream of the power receiver coil 328, which results in detectable high/low voltages reflected across the power transmitter coil 238. In this way, bidirectional half-duplex communications between a tracking module and a base unit surface 260a can occur. Signals are decoded using filters and comparators. The link layer of this network interface 524 is implemented by a UART.

A base unit surface 260a continuously operates power transmitter coils 238 as an inductive proximity sensor in order to detect the docking/undocking of a tracked medication unit 300f. Upon detection, power transfer to the tracking module is initiated. Even a tracking module with a fully discharged battery 356 will be able to communicate with a base unit surface 260a once power transfer is initiated.

In order to prevent magnetic-coupling with an object other than a tracking module, a power transmitter coil 238 is deactivated if prompt communication with a tracking module is not established or if periodic communication attempts fail.

### B.3.6 Sixth Tracked Medication Unit Embodiment

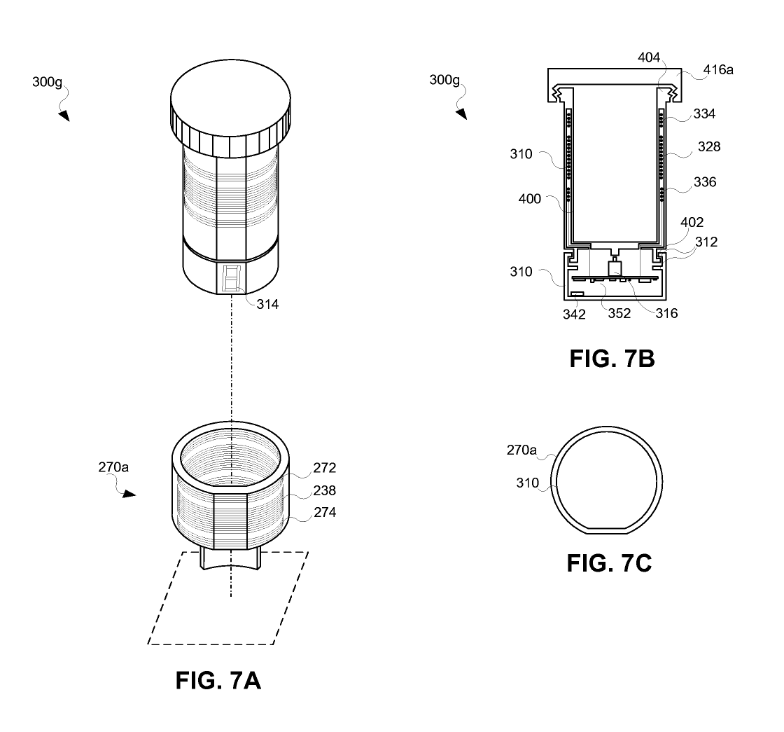

This embodiment of a tracked medication unit 300g has the physical configuration shown in FIGS. 7A, 7B, 7C, & 18A.

The medication container 400 and housing 310 are plastic components. The cavity between their respective sidewalls houses the power receiver coil 328, communication receiver coil 334, and communication transmitter coil 336 of the tracking module. The ends of the coils are routed to the PCB circuitry 352.

A tactile switch 316 is located below the medication container 400, such that a user's push that causes a downward movement of the medication container 400 will actuate the tactile switch 316. This mechanism provides a user-interface for cancellation of an alert generated by the tracking module.

When a tracked medication unit 300g is seated in a base unit holder 270a, the power transmitter coil 238, communication transmitter coil 272d, and communication receiver coil 274 in the base unit holder 270a are respectively aligned with the power receiver coil 328, communication receiver coil 334, and communication transmitter coil 336 in the tracked medication unit 300g.

Inductive coupling of the power transmitter coil 238 and the power receiver coil 328 allows power transfer from the base unit holder 270a to the tracking module. In this way, the internal battery 356 of the tracking module can be charged.

Communication from a base unit holder 270a to a tracking module occurs by transmission of an encoded signal with amplitude modulation from the communication transmitter coil 272 in the base unit holder 270a, which results in detectable high/low voltages induced across the communication receiver coil 334 of the tracking module. Communication from the tracking module to the base unit holder 270a occurs by transmission of an encoded signal with amplitude modulation from the communication transmitter coil 336 of the tracking module, which results in detectable high/low voltages induced across the communication receiver coil 274 in the base unit holder 270a. In this way, bidirectional full-duplex communications between the tracking module and a base unit holder 270a can occur. Signals are decoded using filters and comparators. The link layer of this network interface 524 is implemented by a UART.

When the tracked medication unit 300g is seated in a base unit holder 270a, a magnet 342 in the base of the tracked medication unit 300g aligns with a reed switch sensor located in the flat surface of the base unit below the base unit holder 270a, thus causing actuation of the reed switch sensor. In this way, the docking/undocking of a tracked medication unit 300g can be detected. Upon detection, power transfer to the tracking module is initiated. Even a tracking module with a fully discharged battery 356 will be able to communicate with a base unit holder 270a once power transfer is initiated.

In order to prevent magnetic-coupling with an object other than a tracking module, the power transmitter coil 238 is always deactivated when the reed switch sensor is not actuated. Further, the power transmitter is deactivated if prompt communication with a tracking module is not established or if periodic communication attempts fail.

### B.3.7 Seventh Tracked Medication Unit Embodiment

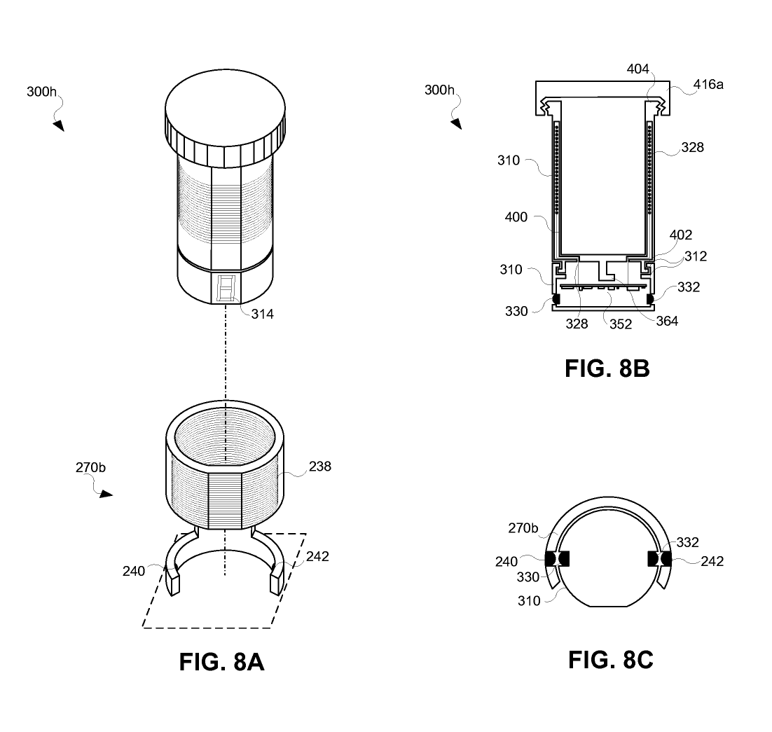

This embodiment of a tracked medication unit 300h has the physical configuration shown in FIGS. 8A, 8B, & 8C.

The medication container 400 and housing 310 are plastic components. The cavity between their respective sidewalls houses the power receiver coil 328 of the tracking module. The ends of the coils are routed to the PCB circuitry 352.

A tactile switch 316 is located in proximity to a paddle 364 attached to the medication container 400, such that a user's twist of the medication container 400 relative to the housing 310 will actuate the tactile switch 316. This mechanism provides a user-interface for cancellation of an alert generated by the tracking module. This mechanism is advantageous because a medication container is less likely to be accidentally rotated. Further, pushing a medication container relative to another portion of the tracked medication unit can fail if the gap between a medication container and the other portion of the tracked medication unit is blocked; rotation (twisting) avoids this problem.

When the tracked medication unit 300h is seated in the base unit holder 270b, the power transmitter coil 238 in the base unit holder 270b is aligned with the power receiver coil 328 in the tracked medication unit 300h.

Inductive coupling of the power transmitter coil 238 and the power receiver coil 328 allows power transfer from a base unit holder 270b to the tracking module. In this way, the internal battery 356 of the tracking module can be charged.

When the tracked medication unit 300h is seated in the base unit holder 270b, the photodiode emitter 240 and photodiode receiver 242 of the base unit holder 270b respectively align with the photodiode receiver 330 and photodiode emitter 332 of the tracking module. Consequently, bidirectional full-duplex IrDA communications between a base unit holder 270b and the tracking module can occur. The link layer of this network interface 524 is implemented by a UART.

The photodiode emitter 240 and photodiode receiver 242 of the base unit holder 270b align, and thus the docking/undocking of a tracked medication unit 300h can be detected. Upon insertion, power transfer to the tracking module is initiated. Even a tracking module with a fully discharged battery 356 will be able to communicate with a base unit once power transfer is initiated.

### B.3.8 Eighth Tracked Medication Unit Embodiment

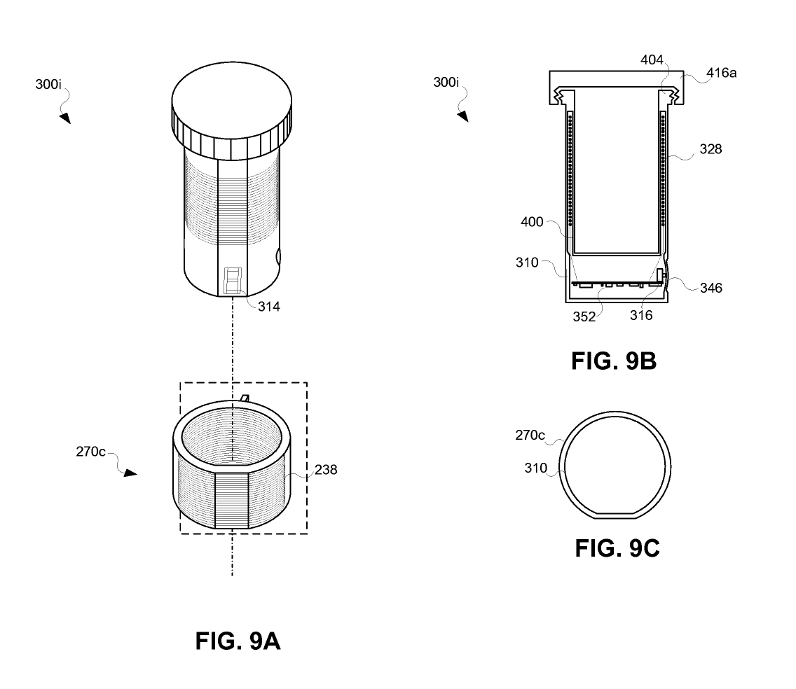

This embodiment of a tracked medication unit 300i has the physical configuration shown in FIGS. 9A, 9B, 9C, & 19A.

The medication container 400 and housing 310 are plastic components of a single part. The cavity between their respective sidewalls houses the power receiver coil 328 of the tracking module. The ends of the coils are routed to the PCB circuitry 352.

A tactile switch 316 with a sealed button cover 346 provides a user-interface for cancellation of an alert issuing from the tracking module.

A thin 7-segment LED numeric display 314 is located on the front side of the tracked medication unit.

When the tracked medication unit 300i is seated in a base unit holder 270c, the power transmitter coil 238 in the base unit holder 270c is aligned with the power receiver coil 328 of the tracking module.

Inductive coupling of the power transmitter coil 238 and the power receiver coil 328 allows power transfer from a base unit holder 270c to the tracking module. In this way, the internal battery 356 of the tracking module can be charged.

An NFC controller, located within the tracked medication unit 300i, can communicate with an NFC controller located in the base unit near the base unit holder 270c. If the tracked medication unit 300i is docked, the NFC controllers are in communication range, and bidirectional half-duplex NFC communications between the base unit holder 270c and the tracking module can occur. The link layer of this network interface 524 is implemented by the NFC controller.

The NFC controller of the tracking module can operate in peer-to-peer mode (active or passive) or emulated card (passive) mode. By switching between modes, the NFC controller of the tracking module can: (a) engage in peer-to-peer communications with an external NFC-enabled device, and (b) enter emulated card mode to permit reading/writing of medication information stored in a tracked medication unit 300i. Passive mode has the advantage of power savings over active mode, and helps preserve battery life (this is especially important when a tracked medication unit 300i is undocked). Peer-to-peer mode has the advantage of permitting an external NFC-enabled device to directly control the operation/settings of a tracked medication unit 300i. Emulated card mode has the advantage of power savings and can implement secure data transactions. The selected mode of operation is based on the operating mode of an external NFC-enabled device and optimal power savings for that mode.

The base unit holder 270c continuously operates each power transmitter coil 238 as an inductive proximity sensor in order to detect the docking/undocking of a tracked medication unit 300i in the base unit holder 270c. Upon detection, power transfer to the tracking module is initiated. Even a tracking module with a fully discharged battery 356 will be able to communicate with a base unit holder 270c once power transfer is initiated.

In order to prevent magnetic-coupling with an object other than a tracking module, the power transmitter coil 238 is deactivated if prompt communication with a tracked medication unit 300i is not established or if periodic communication attempts fail.

### B.3.9 Ninth Tracked Medication Unit Embodiment

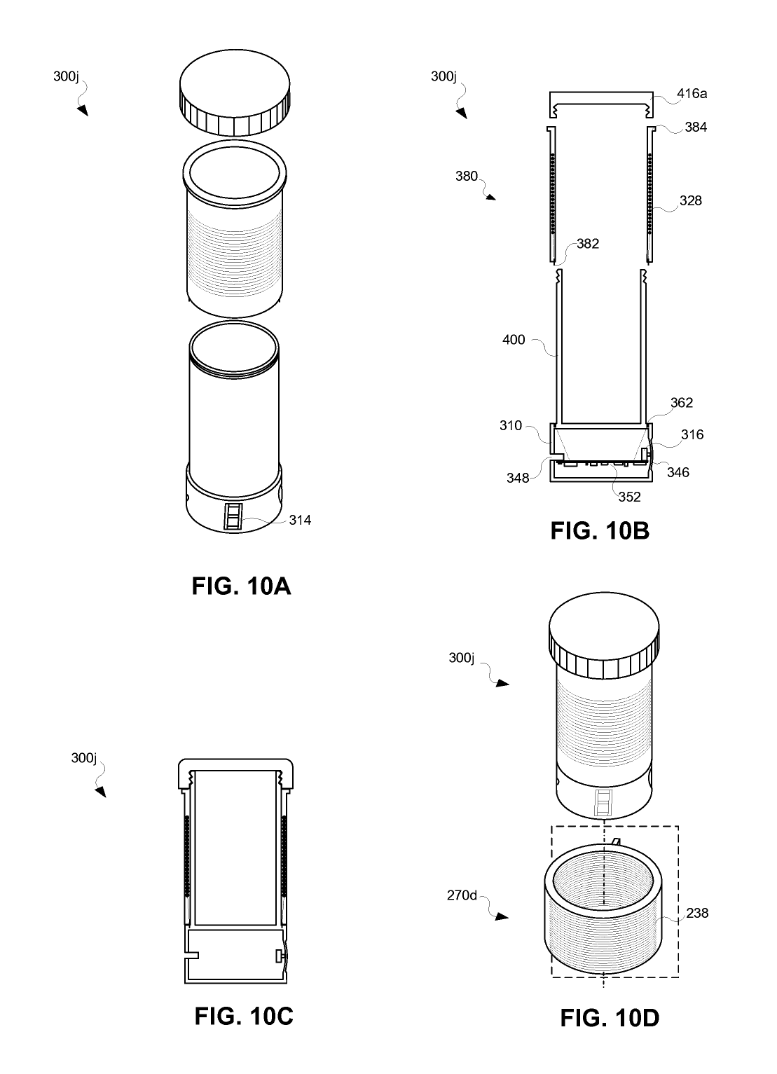

This embodiment of a tracked medication unit 300j has the physical configuration shown in FIGS. 10A, 10B, 10C, 10D, & 21.

The medication container 400 and housing 310 are plastic components of a single part.

The inductive-type shell 380 has an internal power receiver coil 328 for inductive coupling with a power transmitter coil 238, and the ends of the power receiver coil 328 terminate at electrical contact pins 382. When the inductive-type shell 380 is seated over the medication container 400, the electrical contact pins 382 of the inductive-type shell 380 seat within the electrical sockets 362 of the tracking module. The electrical sockets 362 are routed to the charging circuit of the tracking module.

A tactile switch 316 with a sealed button cover 346 provides a user-interface for cancellation of an alert issuing from the tracking module.

A thin 7-segment LED numeric display 314 is located on the front side of the tracked medication unit.

When the tracked medication unit 300j is seated in a base unit holder 270d, inductive coupling of the power transmitter coil 238 and the power receiver coil 328 allows the internal battery 356 of the tracking module to be charged.

Alternatively, a jack socket 348 in the tracking module can seat a jack plug 154 of a power charger 150. The jack socket 348 is electrically connected to the charging circuit of the tracking module, and allows the internal battery 356 of the tracking module to be charged.

The mechanisms for NFC communication with an NFC-enabled external device are described in the above section that pertains to the tracked medication unit 300i embodiment.

### B.3.10 Tenth Tracked Medication Unit Embodiment

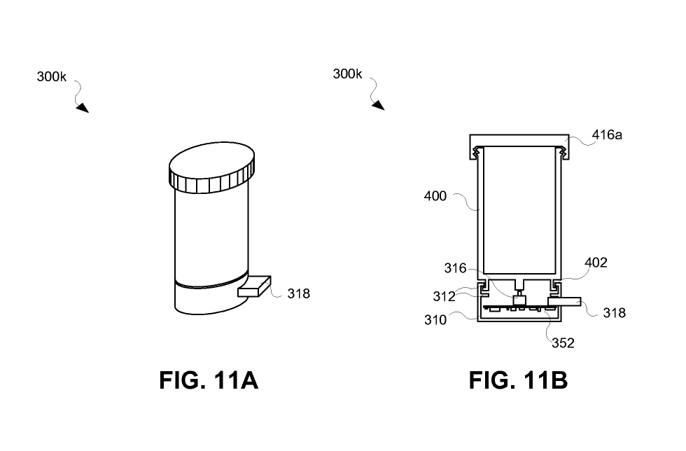

This embodiment of a tracked medication unit 300k has the physical configuration shown in FIGS. 11A, 11B, 20, & 22.

The medication container 400 and housing 310 are plastic components.

A tactile switch 316 is located below the medication container 400, such that a user's push that causes a downward movement of the medication container 400 will actuate the tactile switch 316. This mechanism provides a user-interface for cancellation of an alert generated by the tracking module.

A thin 7-segment LED numeric display 314 is located on the front side of the tracked medication unit.

When the USB device plug 318 of a tracked medication unit 300k is inserted in a USB host receptacle 216 of a USB host device, the tracking module receives power and can communicate with the USB host device. In this way, the internal battery 356 of a tracking module can be charged. The link layer of this network interface 524 is implemented by a USB controller.

The docking of a tracked medication unit to a USB host device is automatically sensed by the USB controller in the USB host device, and communications according to the USB standard commence.

### B.3.11 Eleventh Tracked Medication Unit Embodiment

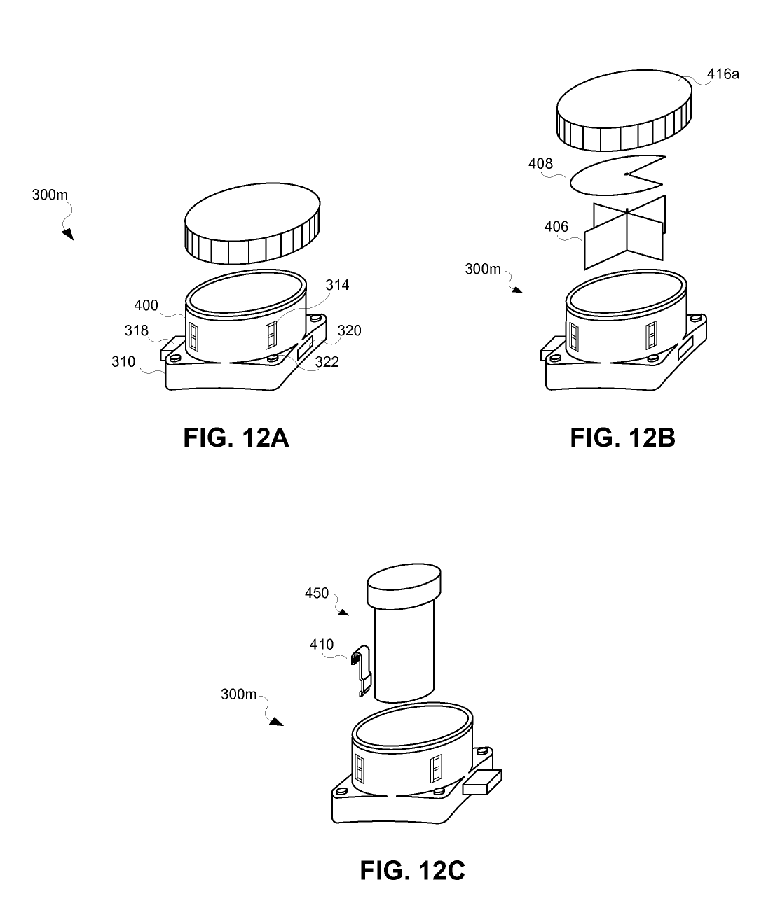

This embodiment of the tracked medication unit 300m has the physical configuration shown in FIGS. 12A, 12B, 12C, 20, & 22.

The medication container 400 and housing 310 are plastic components of a single part.

Four visual indicators 522 consisting of a thin 7-segment LED numeric display 314 are embedded in the sidewall of the medication container 400. The numeric displays 314 are used to alert an end-user and to convey dosage quantity.

Four buttons 322 serve as a user-interface for cancelling alerts issuing from the tracking module. Up to four independent alerts can be issued by the tracking module, one for each possible compartment of the medication container 400. If a single compartment is utilized, then the functionality of the numeric displays 314 and buttons 322 can be duplicated, otherwise each numeric display 314 and button 322 can be associated with an individual compartment.

A divider 406 can be inserted into the medication container 400 in order to create four compartments that align with the four numeric displays 314. Additionally, a rotating cover 408 can be mounted on top of the divider 406 in order to provide selective access to each of the four compartments.

A container clip 410 can be used to removably attach a pharmacy container 450 to the medication container 400. The container clip 410 can be attached to the pharmacy container 450 using an elastic band, tie wrap, tape, etc.

When the USB device plug 318 of a tracked medication unit 300k is inserted in a USB host receptacle 216 of a USB host device, the tracking module receives power from and can communicate with the USB host device. In this way, the internal battery 356 of the tracking module can be charged. The link layer of this network interface 524 is implemented by a USB controller.

The attachment of a tracked medication unit 300k to a USB port is automatically sensed by the USB host controller of the USB host device, and communications according to the USB standard commence. USB hub functionality on the tracking module allows USB daisy-chaining of tracked medication units 300k. Chaining of USB-enabled tracked medication units 300km to the USB host receptacle 216 of a USB host device, allows the USB host device to power and communicate with all chained tracked medication units 300km.

### B.3.12 Twelfth Tracked Medication Unit Embodiment

This embodiment of a tracked medication unit contains a tracking module that is just an unpowered NFC transponder circuit (including antenna) embedded in the base of a medication container. The NFC transponder of the tracking module facilitates reading/writing by an NFC-enabled external device.

A tracked medication unit including this tracking module embodiment is referred to as a tagged medication unit in later sections.

### B.3.13 Thirteenth Tracked Medication Unit Embodiment

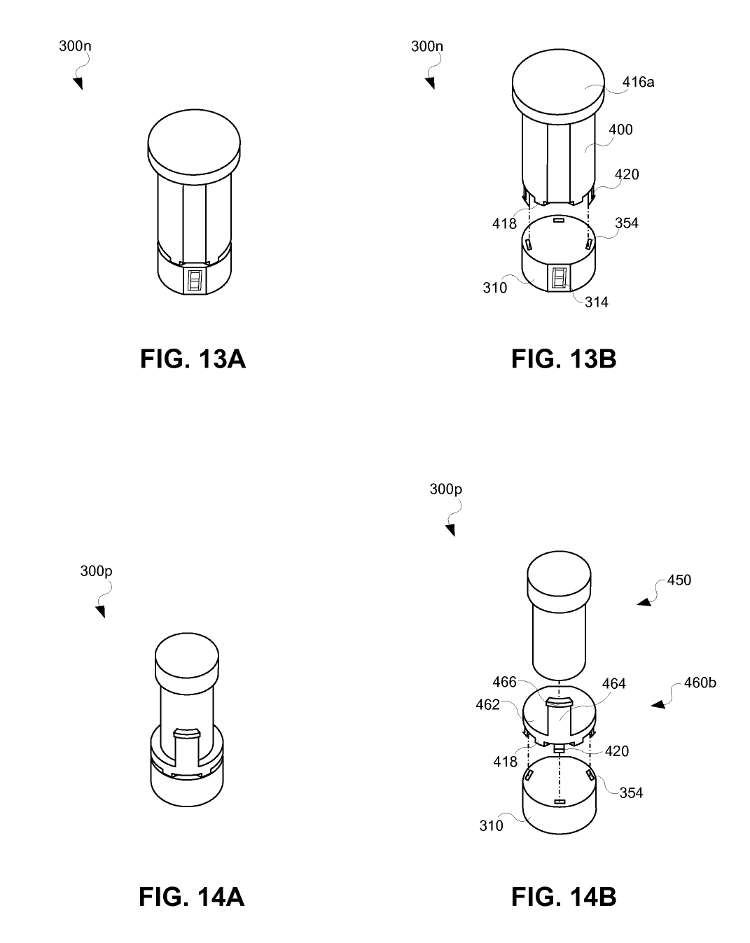

This embodiment of the tracked medication unit 300n has the physical configuration shown in FIGS. 13A & 13B.

The medication container 400 and housing 310 are plastic components. The medication container 400 removably attaches to the housing 310 of a tracking module using standoffs 418 and locking tabs 420 that fit into locking sockets 354.

A thin 7-segment LED numeric display 314 is located on the front side of the tracked medication unit 300n. The internal circuitry of the tracking module is unimportant in this physical configuration example.

### B.3.14 Alternative Tracked Medication Unit Embodiments

The following are alternative embodiments of the tracked medication unit or its components.

Alternative embodiments of the medication container include combinations of some or all of the components and functionalities of the aforementioned medication container embodiments.

Alternative embodiments of the medication container have any suitable shape and size of canister/lid for storing pills, capsules, blister packs, liquids, inhalers, or any other type/form of medication or medical device, including square or rectangular cross-sections.

Alternative embodiments of the medication container have child-friendly forms, or skins for individualizing a medication container.

Alternative embodiments of the medication container implement an attached lid with a flexible link or hinge (this can help prevent the inadvertent switching of lids and permits electrical connections to the lid. Alternative embodiments of a medication container locate tracking module components such as a speaker, battery, and/or visual indicators in the lid.

Alternative embodiments of the medication container eliminate the housing 310 and instead locate large tracking module components such as a speaker and battery in a flexible/hinged lid or medication container portion and position the remaining components in a flexible circuit substrate surrounding the medication container cavity.

Alternative embodiments of the medication container facilitate any suitable mechanism for cancelling an alert issuing from the tracking module; including (a) switch contacts that activate upon rotation of the medication container relative to the tracked medication unit, (b) a touch sensitive surface on the medication container, (c) a user accessible button or switch on the medication container, (d) a pulling motion of the medication container relative to the tracked medication unit, (e) a tilt sensor, or (f) a sensor that detects opening of the lid of a medication container.

Alternative embodiments of the medication container implement permanently molded compartments. This reduces the risk of inadvertent cross-contamination/mixing of medications due to shifting of a compartment divider.

Alternative embodiments of the medication container are constructed of any suitable material, including aluminum, a combination of different plastics, or a combination of plastic and aluminum. For example, clear polycarbonate embedded within an ABS medication container permits viewing of stored medication.

Alternative embodiments of the medication container embed inductive-coils within the sidewalls during the plastic molding process.

Alternative embodiments of the medication container have inductive coils wound in various configurations including planar orientations with respect to the sidewall(s) of the medication container.

Alternative embodiments of the medication container or tracked medication unit have a shell or skin that is purely decorative, has embedded LEDs or lightpipes with an electrical and/or optical interface with a tracking module.

Alternative embodiments of the medication container have any number of compartment dividers or compartments, and provide additional visual indicators to uniquely identify each of the compartments.

Alternative embodiments of the medication container have compartments divided in the horizontal plane, such as with drawers or stacked medication containers, or compartments divided in the vertical plane, such as sectional lift out containers. Alternative embodiments of the medication container that use drawers or horizontal compartments permit access to each drawer/compartment through the sidewall of a tracked medication unit.

Alternative embodiments of the tracking module include combinations of some or all of the components and functionalities of the aforementioned tracking module embodiments.

Alternative embodiments of the tracking module that implement communication by modulation of a power signal use amplitude shift keying, load shift keying, frequency shift keying, and/or phase shift keying modulation techniques.

Alternative embodiments of the tracking module that implement NFC communication with a base unit use electromagnetic shielding, limit the antenna size, and/or tune the antenna circuit to prevent a docked tracked medication unit from communicating with a non-corresponding NFC controller in the base unit.

Alternative embodiments of the tracking module use any combination of audio, visual, or vibrate alert mechanisms, including only a single alert mechanism.

Alternative embodiments of the tracking module do not implement a user interface for cancellation of alerts and instead permit a user to set a predetermined timeout period.

Alternative embodiments of the tracking module do not implement power storage, and rely on the base unit to implement alert functionality. Such embodiments should remain docked when not being accessed by an end-user.

Alternative embodiments of the housing or medication container are constructed using any suitable material, including aluminum, or combinations of plastic and aluminum.

Alternative embodiments of the tracked medication unit include combinations of some or all of the components and functionalities of the aforementioned tracked medication unit embodiments.

Alternative embodiments of the tracked medication unit implement a spring to push/rotate a medication container to its default position within the tracked medication unit.

Alternative embodiments of the tracked medication unit implement a sealed tracking module for harsh environments. A sealed user interface for cancellation of alerts can be achieved using: (a) a sealed button cover, (b) rubber seals, and/or (c) an accelerometer or tilt sensor user-interface. A sealed charging interface can achieved using: (a) inductive charging, and/or (b) sealed electrical contacts. A sealed communication interface can be achieved using: (a) communication over an inductive coil (b) sealed communication contacts, (c) photodiode sensors, and/or (d) NFC communications.

Alternative embodiments of the tracked medication unit locate some or all of their components in the lid of a medication container.

Alternative embodiments of the tracked medication unit facilitate any suitable mechanism for cancelling an alert issuing from the tracking module; including (a) a touch sensitive surface on the tracked medication unit, (b) a user accessible button or switch on the tracked medication unit, (c) an accelerometer for tap/shake detection, or (d) a tilt sensor.

Alternative embodiments of non-USB-enabled tracked medication unit implement a micro USB port, jack socket (e.g. TSSR) or any other suitable charging port. In this way, a tracked medication unit can be portably recharged and/or communicate through that port.

Alternative embodiments of the tracked medication unit embed inductive-coils within the tracked medication unit walls/base during the plastic molding process. Alternative embodiments of the tracked medication unit implement inductive-coils wound in various configurations including planar orientations with respect to the wall(s) of the tracked medication unit.

Alternative embodiments of the tracked medication unit implement inductive coupling mechanisms, provide no electromagnetic shielding or only selective shielding to specific components of the tracking module.

Alternative embodiments of the tracked medication unit implement small-scale power storage, such as a super capacitor. Such embodiments primarily rely on a base unit to implement alert functionality, and only provide short-term dosage information via a visual and/or audio alert when disconnected from a base unit.

Alternative embodiments of the tracked medication unit additionally contain an NFC transponder, which facilitates reading/writing of the transponder contents by an external NFC-enabled device, even when the internal battery of the tracking module is fully discharged. An NFC-enabled mobile communication device running a custom mobile application, can initially write and subsequently read the medication information stored in the NFC transponder. This scenario permits electronic identification of medication stored in a tracked medication unit and rapid automated setup of the medication alerts on the mobile communication device.

Alternative embodiments of the tracked medication unit include a thermoelectric module for refrigeration of temperature-sensitive medications. When the tracked medication unit is docked in a base unit and thus able to receive adequate external power, the thermoelectric module can be used to refrigerate the medication container. Alternative embodiments include a thermoelectric module in the lid of the medication container with a heat sink on top.

Alternative embodiments of the tracked medication unit implement a locking mechanism for the lid, such that a lid is not openable until a medication dosage is due. Alternative embodiments of the tracked medication unit implement a locking mechanism for the lid and tracked medication unit, such that an end-user is required to enter a code on the base unit in order to open the lid or undock the tracked medication unit from the base unit. Alternative embodiments of the tracked medication unit are docked such that the lid is inaccessible/unopenable while the tracked medication unit is docked.

The skilled reader will appreciate that each embodiment of a medication container, tracking module, or tracked medication unit provides just one example of a multitude of suitable configurations and operational methods for hardware, firmware, and software, and that various changes, omissions, modifications, and additions may be made to each embodiment without departing from the scope of the invention.

### B.4 Tracked Medication Adapter

Some residential care facilities require medications to remain in their original pharmacy-issued containers 450. This policy has the advantage of preserving pharmacy labeling information, reducing the risk of cross-contamination, and avoiding errors in medication transfer.

A pharmacy container 450 is converted to a tracked medication unit through use of a tracked medication adapter 460.

### B.4.1 First Tracked Medication Adapter Embodiment

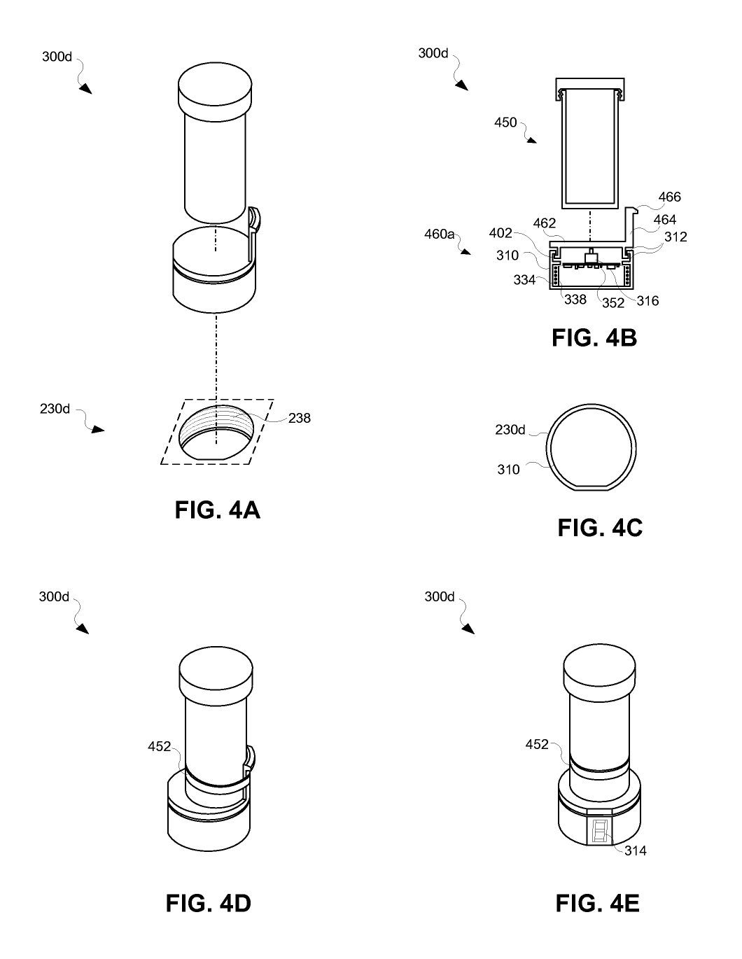

This embodiment of a tracked medication adapter 460a has the physical configuration shown in FIGS. 4A, 4B, 4C, 4D, & 4E.

The tracked medication adapter 460a, which includes a tracking module, removably attaches to a pharmacy container 450 to form a tracked medication container 300d.

The outer foot 402 of the tracked medication adapter 460a is retained between the retaining flanges 312 of the housing 310. The distance between the retaining flanges 312 is sufficient to allow the pharmacy container 450 to travel vertically by 2 mm. A tactile switch 316 is mounted directly below the tracked medication adapter 460a. A user's push that causes a downward movement of the tracked medication adapter 460a will actuate the tactile switch 316. Upon release of the tracked medication adapter 460a, the tactile switch 316 will snap back and push the tracked medication adapter 460a back up. This mechanism serves as a user-interface for cancelling an alert issuing from a tracking module.

The tracked medication adapter 460a uses a base 462, backstop 464, and backstop rim 466 for attachment to a medication container. Attachment of the pharmacy container 450 to the tracked medication adapter 460a can be achieved in several ways, such as with: (a) an elastic band 452 or Velcro strip wrapped around the pharmacy container 450 and backstop 464, (b) a removable adhesive pad bonding the back of the pharmacy container 450 to the backstop 464, (c) a removable adhesive pad bonding the base of the pharmacy container 450 to the base 462, and/or (d) a removable, preferably clear, adhesive tape wrapped around the pharmacy container 450 and backstop 464. In the case of (a), the backstop rim 466 helps prevent the elastic band 452 from slipping off the top of the backstop 464.

A thin 7-segment LED numeric display 314 is located on the front side of the tracked medication adapter 460a.

A thin layer of ferrite and copper shielding 338 between the power receiver coil 328 and the remainder of the internal circuitry of the tracking module, shields the remaining circuitry of the tracking module from excessive electromagnetic noise.

When the tracked medication adapter 460a is seated in a base unit well 230d, the power transmitter coil 238 (embedded in the sidewall of the base unit well 230d) is in close proximity to the power receiver coil 328 of the tracking module. Inductive coupling of the power transmitter coil 238 and power receiver coil 328 allows power transfer from a base unit well 230d to the tracking module. In this way, the internal battery 356 of the tracking module can be charged.

Communication from a base unit well 230d to the tracking module occurs by amplitude key shifting of the power signal transmitted by the power transmitter coil 238, which results in detectable high/low voltages induced across the power receiver coil 328. Communication from the tracking module to a base unit well 230d occurs by load key shifting downstream of the power receiver coil 328, which results in detectable high/low voltages reflected across the power transmitter coil 238. In this way, bidirectional half-duplex communications between the tracking module and a base unit well 230d can occur. Signals are decoded using filters and comparators. The link layer of this network interface 524 is implemented by a UART.

The power transmitter coil 238 in a base unit well 230d is continuously operated as an inductive proximity sensor in order for a base unit well 230d to detect the docking/undocking of a tracked medication adapter 460a. Upon insertion, power transfer to the tracking module is initiated. Even a tracking module with a fully discharged battery 356 will be able to communicate with a base unit well 230d once power transfer is initiated.

In order to prevent magnetic-coupling with an object other than a tracking module, a power transmitter coil 238 is deactivated if prompt communication with a tracking module is not established or if periodic communication attempts fail.

### B.4.2 Second Tracked Medication Adapter Embodiment

This embodiment of a tracked medication adapter 460b has the physical configuration shown in FIGS. 14A & 14B.

The tracked medication adapter 460b, which does not include a tracking module, removably attaches to a pharmacy container 450.

The tracked medication adapter 460b uses a base 462, backstop 464, and backstop rim 466 for attachment to a medication container. Attachment of the pharmacy container 450 to the tracked medication adapter 460b can be achieved in the same ways as disclosed for a tracked medication adapter 460a.

The tracked medication adapter 460b removably attaches to the housing 310 of a tracking module using standoffs 418 and locking tabs 420 that fit into locking sockets 354. The tracking module components and functionality are unimportant in this physical configuration example.

### B.4.3 Third Tracked Medication Adapter Embodiment

This embodiment of a tracked medication adapter is similar to the first embodiment of a tracked medication adapter 460a, except that the base and backstop are tilted backwards by 30 degrees so that an attached pharmacy container 450 is likewise tilted. Apart from better readability of the pharmacy container 450 label, the pharmacy container 450 is less likely to slip out of a retaining elastic band when retrieved from a base unit.

### B.4.4 Alternative Tracked Medication Adapter Embodiment

Alternative embodiments of the tracked medication adapter have any suitable shape and size for attachment to any pharmacy container 450, or any other medication container, or medical device.

Alternative embodiments of the tracked medication adapter do not have a backstop rim 466, and instead mount a retaining band or other mechanism on the backstop 464 for releasable retention of a pharmacy container 450.

Alternative embodiments of the tracked medication adapter utilize any suitable method for amalgamation to a tracking module, including (a) removable attachment, and (b) application of any method previously disclosed for amalgamation of a medication container with a tracking module.

Alternative embodiments of the tracked medication adapter utilize any suitable mechanism for cancelling an alert issuing from the tracking module, including application of any method previously disclosed for cancelling an alert issuing from a tracking module.

### B.5 Standalone Base Unit

### B.5.1 General Description of First-Sixth Standalone Base Unit Embodiments

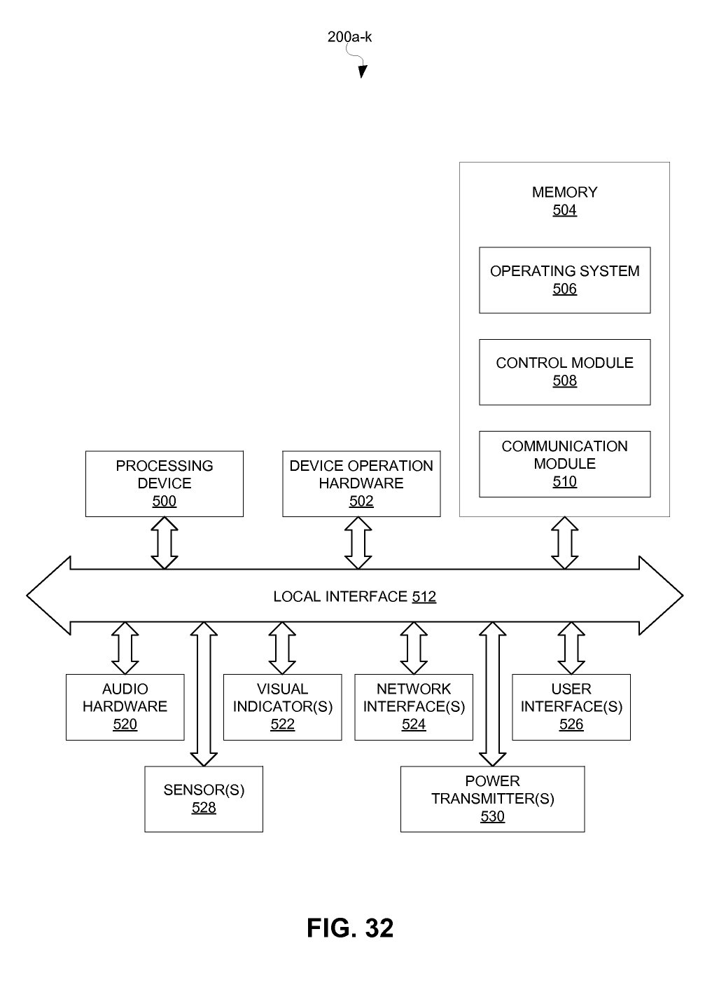

Base unit embodiments 200a-f have the architecture shown in FIG. 32.

Base unit embodiments 200a-f have a plastic casing.

The processing device 500 is adapted to execute commands stored in memory 504 and comprises a general-purpose processor, a micro-processor, one or more application specific integrated circuits (ASICs), a plurality of suitably configured digital logic gates, and other known electrical configurations comprising discrete elements both individually and in various combinations to coordinate the overall operation of the base unit 200a-f.

The device operation hardware 502 comprises the various components used for the operation of the base unit 200a-f, including a backup battery, power regulation circuitry, and real-time clock. The local interface 512 comprises the electrical interconnections between the components.

The memory 504 includes an operating system 506, a control module 508, and a communication module 510. The operating system 506 contains the various commands used to control the general operation of the base unit 200a-f. The communication module 510 comprises software or firmware that is adapted, in conjunction with the network interface 524 devices, to facilitate external communications. The control module 508 comprises the software/firmware which controls the operation of the base unit 200a-f.

The audio hardware 520 comprises the basic components necessary to generate sounds using a speaker. The speaker is used to generate alerts tones, event tones (e.g. on docking of a tracked medication unit), and voice synthesized messages. LED visual indicators 522 individually signal the docking of a tracked medication unit on the base unit 200a-f.

When a base unit extension 280a-f is connected to the base unit 200a-f, the base unit 200a-f takes control of the added docking interfaces in addition to its own docking interfaces. The base unit extension 280a-f transparently connects each docked tracked medication unit to the base unit 200a-f, such that the base unit 200a-f equivalently controls all docked tracked medication units whether on a base unit extension 280a-f or the base unit 200a-f. This effectively creates a larger base unit. Discussion about the operation of the base unit 200a pertains equally to the larger base unit.

Sensors 528 on a base unit 200a-f permit detection of a docked tracked medication unit.

The general operation of the base unit 200a-f includes: (a) implementation of an interface for end-user interaction with the base unit 200a-f, such as an LCD touchscreen 202 and function buttons 214, (b) control of any connected base unit extensions 280a-f, (c) recharge of connected tracking modules, (d) communication with connected tracking modules, and (e) emission of medication alerts.

On initial configuration, the base unit 200a-f typically guides an end-user through the following steps: (a) docking a tracked medication unit, (b) associating a medication type with the unique ID of the docked tracking module, and (c) entering the medication schedule, dosages, usage directions, and alert-options associated with that medication type, and (d) entering configuration settings, such as event tones. This medication information is then stored in the memory 504 of the base unit 200a-f and transmitted to the docked tracking module.

On non-initial configuration, the base unit 200a-f typically allows an end-user to: (a) edit the previously submitted medication information, and (b) view event data that was generated on the base unit 200a-f and tracked medication unit.

When a tracked medication unit is docked, the base unit 200a-f typically performs the following steps: (a) detects the tracking module, (b) initiates power transfer to the tracking module, (c) requests the unique ID of the tracking module, (d) uses stored association data to determine the medication type stored in the tracked medication unit, (e) synchronizes the date/time setting on the tracking module, and (f) uploads any stored event data from the tracking module.

### B.5.2 First Standalone Base Unit Embodiment

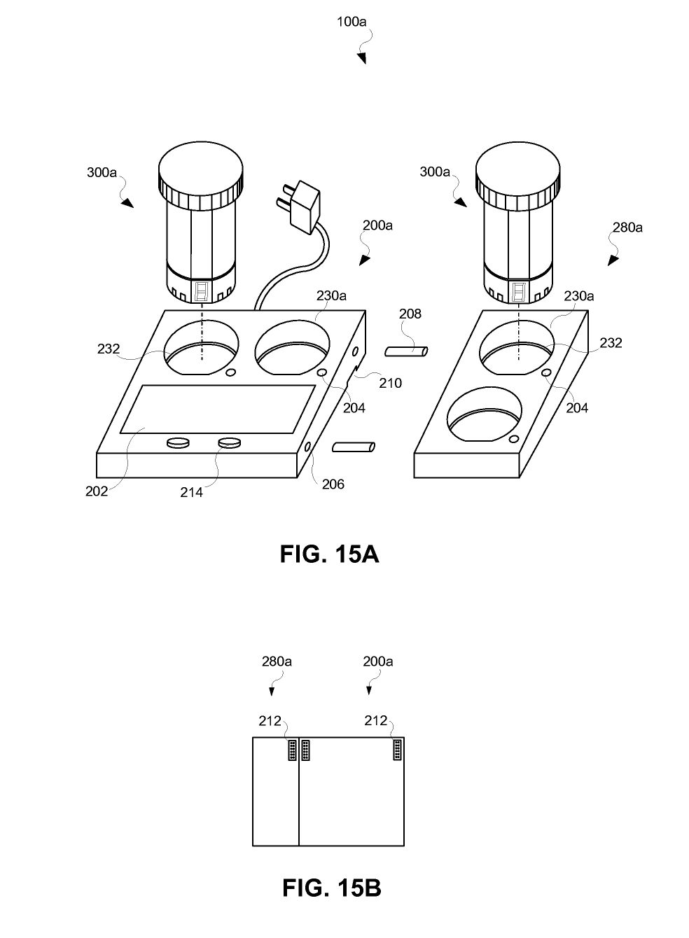

This embodiment of a base unit 200a has the physical configuration shown in FIGS. 15A & 15B.

The base unit wells 230a are keyed to ensure that a tracked medication unit 300a is seated in a specific orientation. The spring-loaded electrical contacts 234 are molded in the sidewall of each base unit well 230a in order to maintain a sealed well. The base unit wells 230a have an open base, with a slight rim 232 at the base of the sidewall to seat an inserted tracked medication unit 300a. The open base is useful to prevent an accumulation of debris in the well.

Left and right side extension connectors 212 permit electrical connection of up to two base unit extensions 280a via jumper cables. The sidewall cutouts 210 facilitate routing of jumper cables. Two network interfaces 524 within the base unit 200a are UARTS that individually facilitate RS232 communication with a connected base unit extension 280a.

The mechanisms for power transfer to and communication with a tracked medication unit 300a are described in the above section that pertains to the tracked medication unit 300a embodiment.

### B.5.3 Second Standalone Base Unit Embodiment

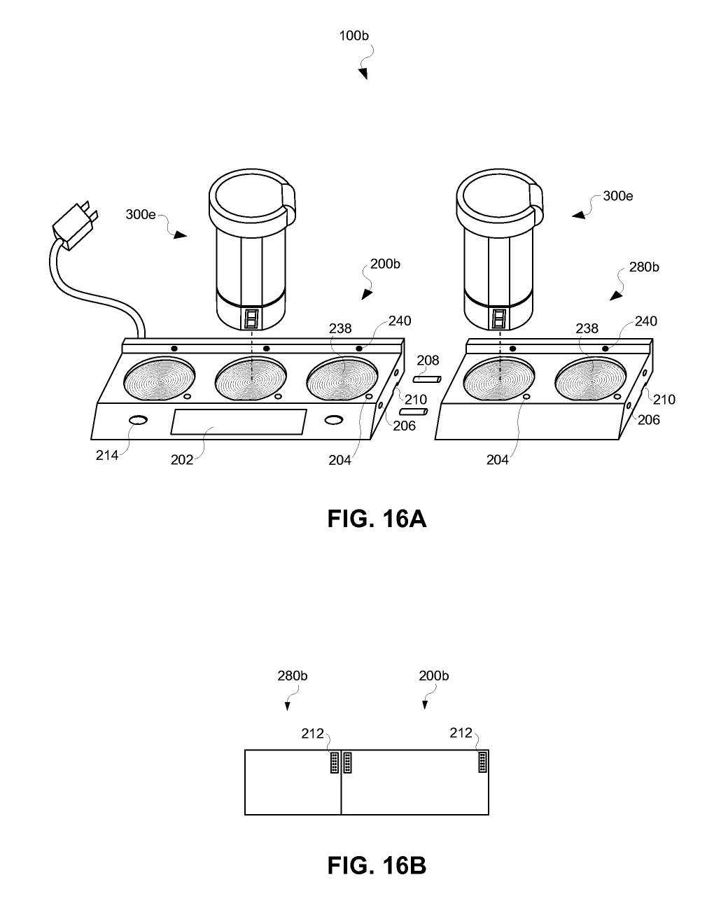

This embodiment of a base unit 200b has the physical configuration shown in FIGS. 16A & 16B.

The base unit wells 230e are keyed to ensure that a tracked medication unit 300e is seated in a specific orientation.

Left and right side extension connectors 212 permit electrical connection of up to two base unit extensions 280b via jumper cables. The sidewall cutouts 210 facilitate routing of jumper cables. Two network interfaces 524 within the base unit 200b are UARTS that individually facilitate RS232 communication with a connected base unit extension 280b.

The mechanisms for power transfer to and communication with a tracked medication unit 300e are described in the above section that pertains to the tracked medication unit embodiment 300e.

### B.5.4 Third Standalone Base Unit Embodiment

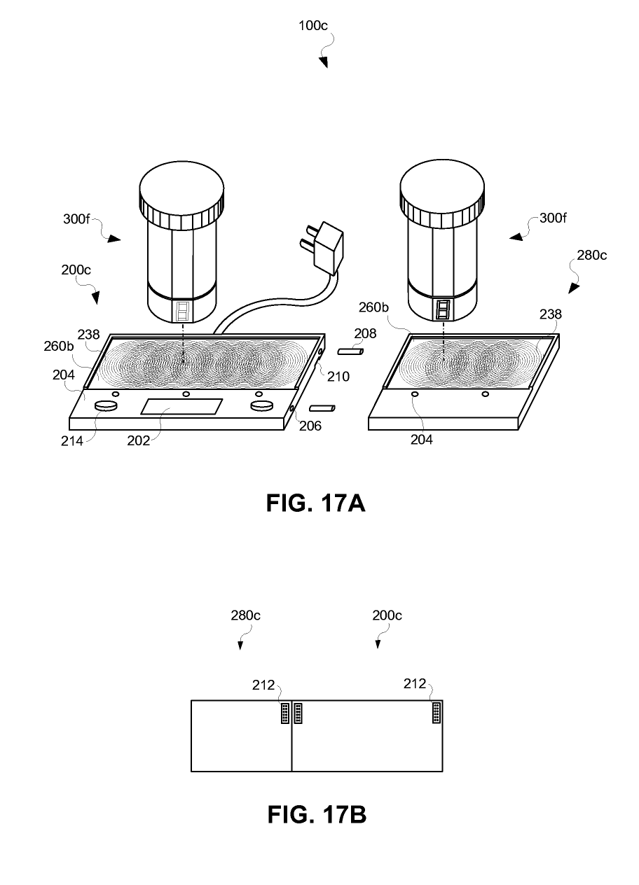

This embodiment of a base unit 200c has the physical configuration shown in FIGS. 17A & 17B.

A tracked medication unit 300f can be placed anywhere on the base unit surface 260b.

Left and right side extension connectors 212 permit electrical connection of up to two base unit extensions 280c via jumper cables. The sidewall cutouts 210 facilitate routing of jumper cables. Two network interfaces 524 within the base unit 200c are UARTS that individually facilitate RS232 communication with a connected base unit extension 280c.

Embedded within the base unit surface 260b is a one-dimensional array of power transmitter coils 238 such that one of the coils is always within close proximity to the power receiver coil 328 of a tracked medication unit 300f seated anywhere on the base unit surface 260b.

The mechanisms for power transfer to and communication with a tracked medication unit 300f are described in the above section that pertains to the tracked medication unit embodiment 300f.

### B.5.5 Fourth Standalone Base Unit Embodiment

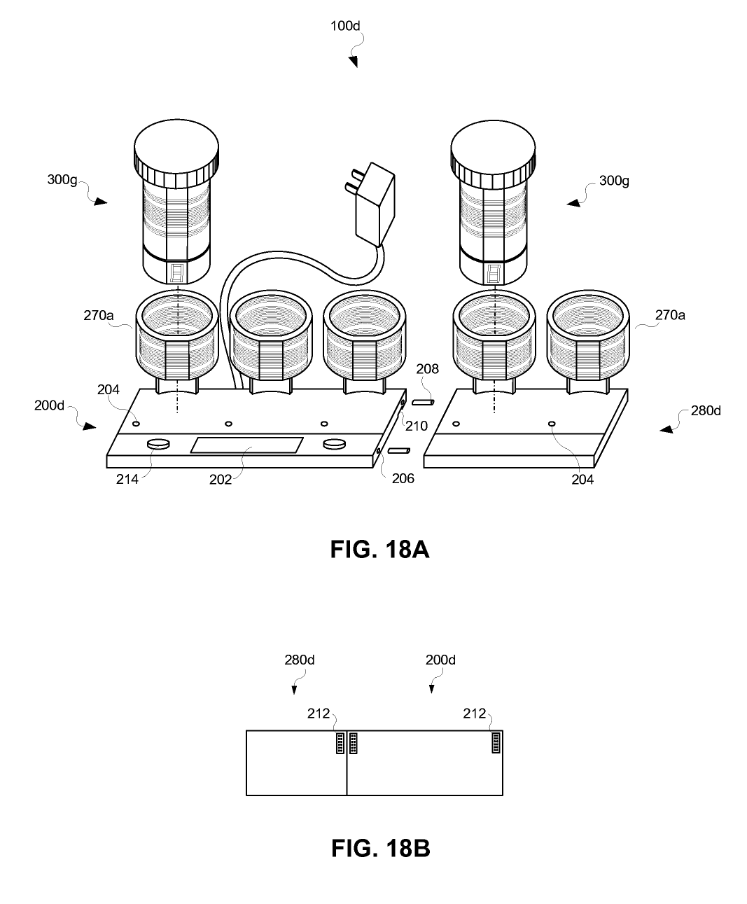

This embodiment of a base unit 200d has the physical configuration shown in FIGS. 18A & 18B.

The base unit holders 270a are keyed to ensure that a tracked medication unit 300g is seated in a specific orientation. The base unit holders 270a are open at both ends in order to allow an inserted tracked medication unit 300g to be seated on the flat surface of the base unit 200d.

Left and right side extension connectors 212 permit electrical connection of up to two base unit extensions 280d via jumper cables. The sidewall cutouts 210 facilitate routing of jumper cables. Two network interfaces 524 within the base unit 200d are UARTS that individually facilitate RS232 communication with a connected base unit extension 280d.

The mechanisms for power transfer to and communication with a tracked medication unit 300g are described in the above section that pertains to the tracked medication unit embodiment 300g.

### B.5.6 Fifth Standalone Base Unit Embodiment

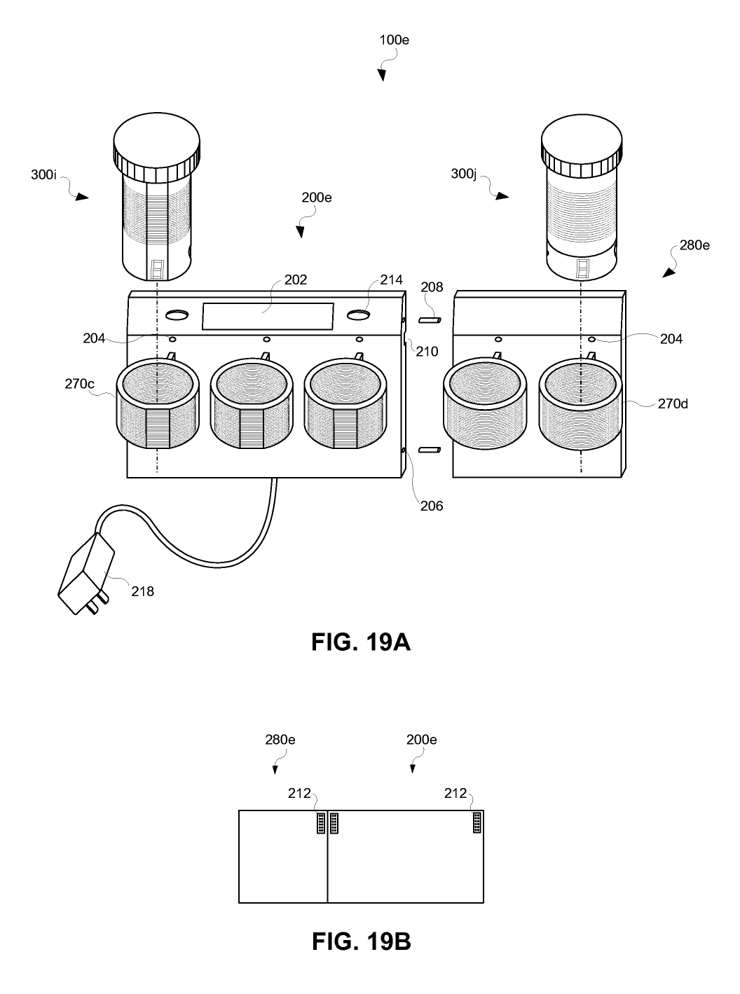

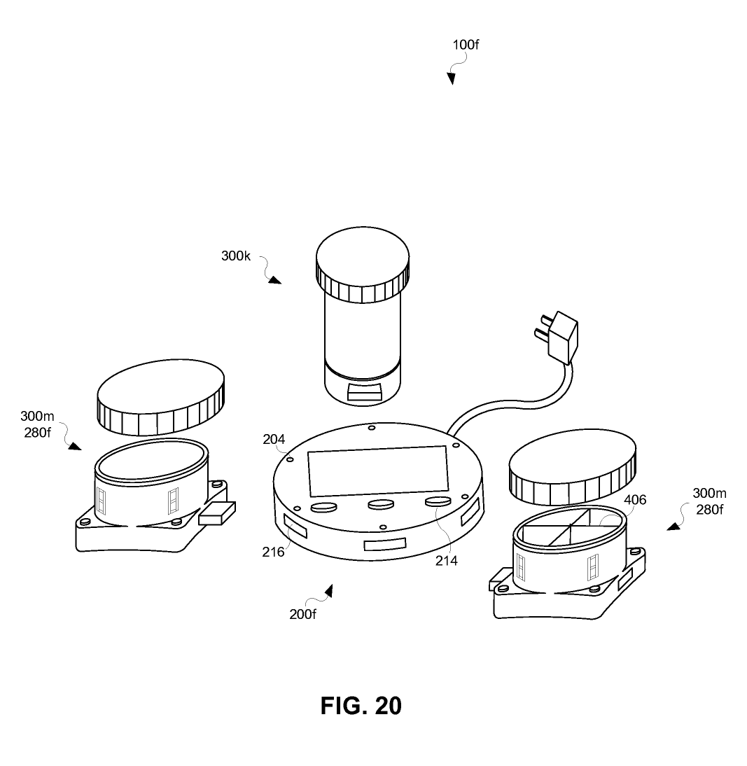

This embodiment of a base unit 200e has the physical configuration shown in FIGS. 19A & 19B.

The base unit holders 270c are keyed to ensure that the numeric display 314 of the tracked medication unit 300i is facing forwards. The base unit holders 270c are open at both ends and the tracked medication unit 300i is retained in the base unit holder 270c by the collar 384/404 of the tracked medication units 300i.

Left and right side extension connectors 212 permit electrical connection of up to two base unit extensions 280e via jumper cables. The sidewall cutouts 210 facilitate routing of jumper cables. Two network interfaces 524 within the base unit 200e are UARTS that individually facilitate RS232 communication with a connected base unit extension 280e.

The mechanisms for power transfer to and communication with a tracked medication unit 300i are described in the above section that pertains to the tracked medication unit embodiment 300i.

DC power is supplied to the base unit 200e from an AC-DC adapter with an integrated powerline communication coupler 218. One of the network interfaces 524 on the base unit 200e is a powerline transceiver, which facilitates bidirectional communications with one or more alert-extensions 480a plugged into any AC power outlet of the same building. In this way, alerts issuing from the base unit 200e can be extended to multiple areas of a building.

### B.5.7 Sixth Standalone Base Unit Embodiment

This embodiment of a base unit 200f has the physical configuration shown in FIG. 20.

A multi-port USB host controller within the base unit 200f facilitates USB communication with multiple docked tracked medication units 300km.

The mechanisms for power transfer to and communication with tracked medication units 300km are described in the above sections that pertain to the tracked medication unit embodiments 300km.

Each tracked medication unit 300m can function as a base unit extension 280f through connection of another tracked medication unit 300km to its USB hub receptacle 320.

Event logs and configuration data stored on the base unit 200f can be downloaded to a USB flash drive plugged into a USB host receptacle 216 on the base unit 200f.

### B.5.8 Seventh Standalone Base Unit Embodiment

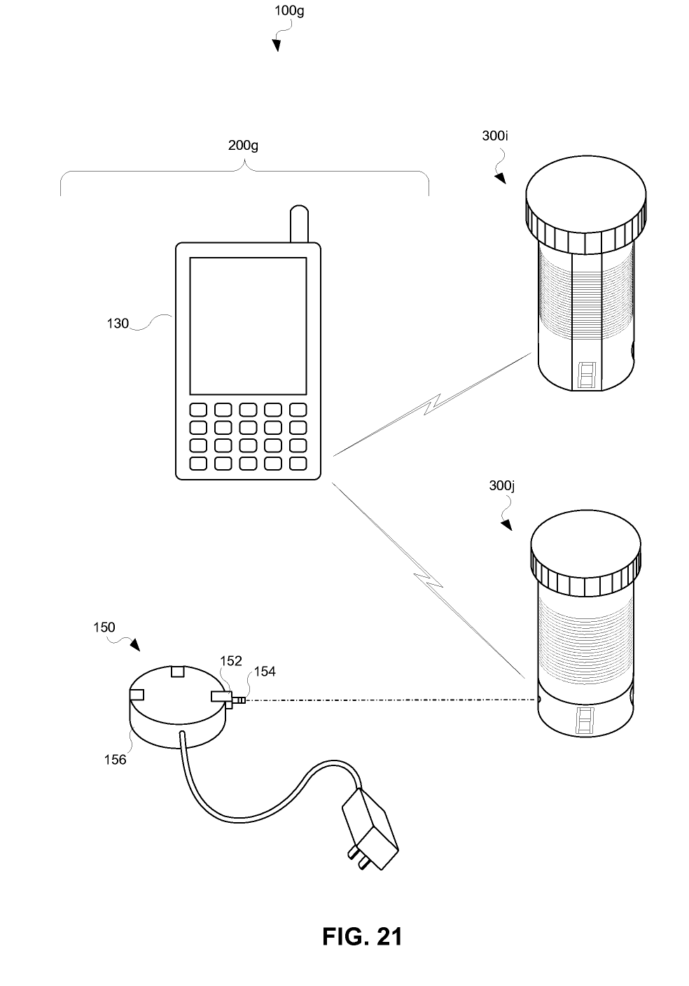

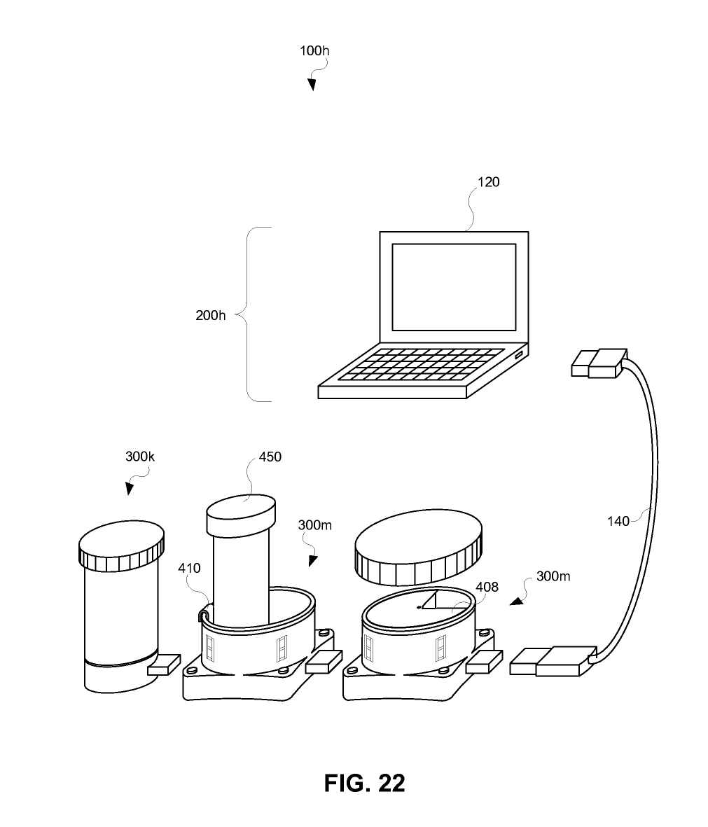

This embodiment of a base unit 200g shown in FIG. 21 is a combination of two separate devices—a power charger 150 and an NFC-enabled mobile communication device 130 (e.g. a smart phone) running a custom mobile application.

Each jack plug 154 on the power charger 150 is mounted on a swivel plug base 152, which allows unused jack plugs 154 to be recessed within the housing 156 of the power charger 150.

The mechanisms for power transfer to and communication with a tracked medication unit 300ij are described in the above sections that pertain to the tracked medication unit embodiments 300ij.

A custom mobile application running on a NFC-enabled mobile communication device 130 that operates in peer-to-peer mode can communicate with the NFC controller in a tracked medication unit 300ij. The custom mobile application can: (a) initially write a medication schedule, dosages, and alert-options (incl. usage directions) into a tracked medication unit 300ij, (b) access and display the medication information stored in the tracked medication unit 300ij, (c) use the uploaded medication information to configure medication alerts on the mobile communication device 130, (d) enable/disable audio and/or visual alerts on the tracked medication unit 300ij, (e) modify the medication information on the tracked medication unit 300ij, (f) synchronize the date/time setting on the tracked medication unit 300ij, and (g) upload and display stored event data from the tracked medication unit 300ij. The NFC-enabled mobile communication device 130 uses passive peer-to-peer communication for power savings on a target tracked medication unit 300ij.

A custom mobile application running on the NFC-enabled mobile communication device 130 that operates as a reader/writer can read data from the NFC controller in a tracked medication unit 300ij operating in card emulation mode. In this way, the medication type/schedule associated with the attached medication container can be read (or written). An NFC-enabled mobile communication device 130 in close proximity to the tracked medication unit 300i can access and display the medication information for an end-user. Furthermore, a mobile application running on the NFC-enabled mobile communication device 130 can use the medication information to configure independent medication alerts on the NFC-enabled mobile communication device 130.

For a tracked medication unit 300j, the base unit 200g embodiment provides a more mobile counterpart to the base unit 200e (using base unit extension 280e).

### B.5.9 Eighth Standalone Base Unit Embodiment

This embodiment of a base unit 200h shown in FIG. 22 is a computing device 120 (e.g. laptop) with a USB port.

A tracked medication unit 300km can be connected to the computing device 120 with a USB cable 140.

The mechanisms for power transfer to and communication with tracked medication units 300km are described in the above sections that pertain to the tracked medication unit embodiments 300km.

A custom software application running on a USB host device can use the USB port to communicate with a connected tracked medication unit 300km. Consequently, the custom software application can: (a) initially program a medication schedule, dosages, and alert-options (incl. usage directions) into a tracked medication unit 300km, (b) access and display the medication information stored in the tracked medication unit 300km, (c) modify the medication information on the tracked medication unit 300km, (d) synchronize the date/time setting on the tracked medication unit 300km, and (e) upload and display stored event data from the tracked medication unit 300km.

### B.5.10 Ninth Standalone Base Unit Embodiment

This embodiment of a base unit is an NFC-enabled mobile communication device 130 (e.g. a smart phone) running a custom mobile application.

A custom mobile application running on a NFC-enabled mobile communication device 130 can use the NFC port to read/write to the unpowered NFC transponder in a tagged medication unit. Consequently, the custom mobile application can: (a) write a medication schedule, dosages, and alert-options (incl. usage directions) to the tagged medication unit, (b) read and display the medication information stored on the tagged medication unit, and (c) use the uploaded tag contents to automatically configure medication alerts on an NFC-enabled mobile communication device 130 in order for the custom mobile application to emit medication alerts at the scheduled times.

### B.5.11 Alternative Standalone Base Unit Embodiments

Alternative embodiments of the base unit include combinations of some or all of the components and functionalities of the aforementioned base unit embodiments.

Alternative embodiments of the base unit implement base unit wells/holders/surfaces of any suitable shape, size, or quantity, including those that seat only a portion, protruding or otherwise, of a tracked medication unit.

Alternative embodiments of the base unit distribute functionality to base unit extensions, such as base units with no docking interfaces for tracked medication units, which instead rely on one or more base unit extensions to provide docking interface functionality.

Alternative embodiments of the base unit use any other suitable interlocking mechanism for attachment to a base unit extension, including the use of clips, threaded connectors (such as thumb screws), and magnets.

Alternative embodiments of the base unit implement an array of inductive power/communication coils as a one, two, or three dimensional array. Alternative embodiments of the base unit implement an array of inductive power/communication coils that can auto-align with the placement of a tracked medication unit through use of magnets.

Alternative embodiments of the base unit use any other suitable user interface, including any type of display technology, keyboard input, and/or speech recognition engine.

Alternative embodiments of the base unit include a vibrate mechanism, voice synthesized message, a braille display, or any other type of assistive device.

Alternative embodiments of the base unit distribute functionality to tracked medication units, such as base units with no audio and/or visual capabilities, and instead rely on the audio/visual capabilities of a tracked medication unit to provide this functionality.

Alternative embodiments of the base unit distribute functionality over several devices, such as a base unit which only performs charging of tracked medication units.

Alternative embodiments of the base unit are constructed using any suitable material, including aluminum.

Alternative embodiments of the base unit have any suitable form or size, including medicine cabinet, wall mountable, or table top forms. A medicine cabinet form with a lockable door would allow medications to be stored more privately and facilitate thermoelectric refrigeration.

Alternative embodiments of the base unit with electrical contacts for supply of power to a tracked medication unit, substantially separate the power/ground electrical contacts, recess them, and/or shroud them in order to reduce the likelihood of accidental short-circuiting.

Alternative embodiments of the base unit that implement communication by modulation of a power signal use amplitude shift keying, load shift keying, frequency shift keying, and/or phase shift keying modulation techniques.

Alternative embodiments of the base unit with electrical contacts for supply of power to a tracked medication unit, include a reed switch sensor near each base unit well/holder. A docked tracked medication unit with a magnet activates the reed switch sensor, whereupon the electrical contacts are powered.

Alternative embodiments of the base unit use any other suitable method for communication with base unit extensions, including use of USB, RS485, LIN, or CAN networks. Alternative embodiments of the base unit permit connection with more than two base unit extensions including chained base unit extensions.

Alternative embodiments of the base unit have a ‘tap and display’ area on their exterior casing. By tapping a tracked medication unit in that area of the base unit, an NFC controller beneath the tap area will establish communication with the tapped tracked medication unit and display the medication information on the base unit's LCD screen. This mechanism solves the problem of deciding which medication information to display on the LCD display if multiple medication alerts emit concurrently.

Alternative embodiments of the base unit utilize a single NFC controller to communicate with multiple tracked medication units.

Alternative embodiments of the base unit utilize RFID, Zigbee, wireless USB, low-power Bluetooth, TransferJet, or any other suitable RF network for communication with a tracked medication unit.

Alternative embodiments of the base unit utilize any optical hardware, protocol, or wavelength for communication with a tracked medication unit.

The skilled reader will appreciate that each embodiment of a standalone base unit provides just one example of a multitude of suitable configurations and operational methods for hardware, firmware, and software, and that various changes, omissions, modifications, and additions may be made to each embodiment without departing from the scope of the invention.

### B.6 Web-Accessible Base Unit

In cases where an end-user or care-provider requires remote access to a base unit, the web-enabled base unit is suitable.

Web access is implemented by connecting a base unit (directly or indirectly) to a network server, which hosts a website through which a user can access the base unit. This interaction includes: (a) configuring the operation of the web-accessible base unit, (b) editing medication information including alert options on the web-accessible base unit, and (c) retrieving event data from the web-accessible base unit.

### B.6.1 First Web-Accessible Base Unit Embodiment

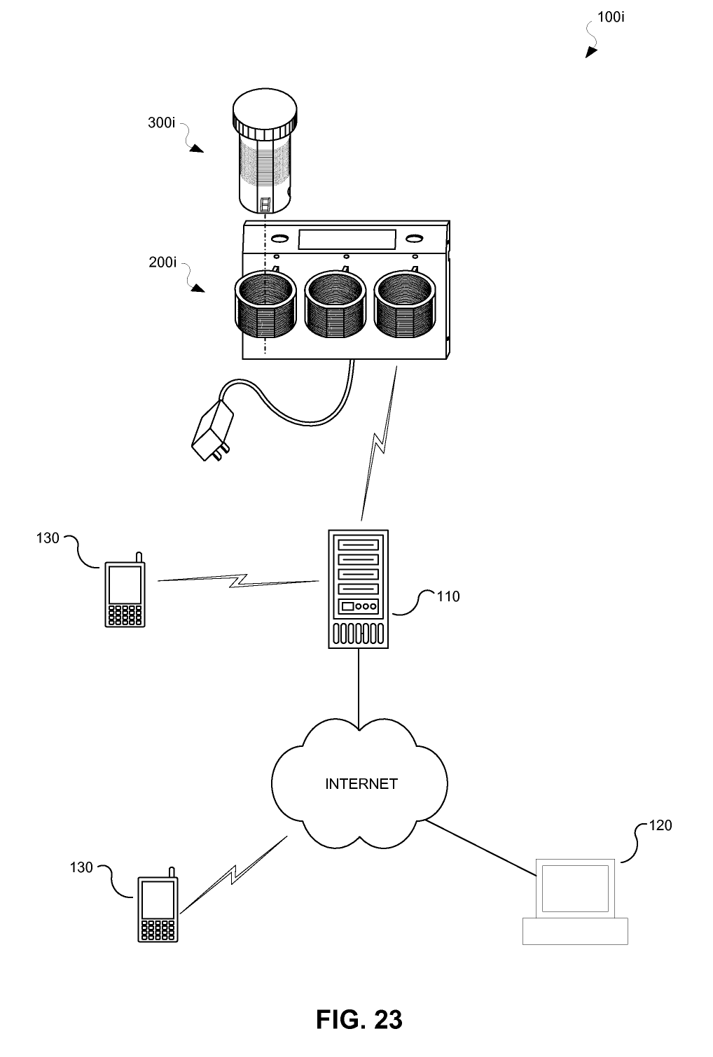

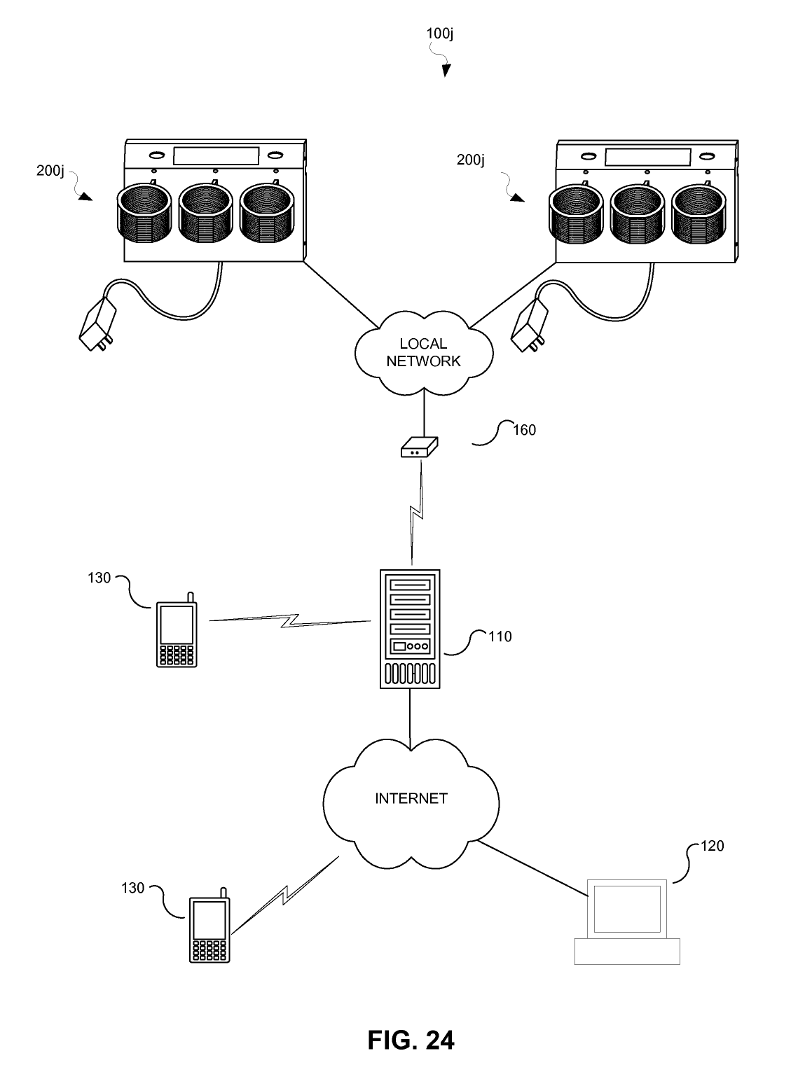

This embodiment of a web-accessible base unit 200i is shown in FIG. 23.

The web-accessible base unit 200i includes the architecture, components, operation, and functionality of a standalone base unit embodiment 200e, together with a cellular network interface for communication with a remote network server 110 via a cellular network.

The network interface provides a remote user-interface in addition to the physical user-interface on the web-accessible base unit 200i.

The standalone base unit embodiment 200e is designed to accommodate easy end-user upgrade to a web-accessible base unit 200i by installation of a cellular modem.

### B.6.2 Second Web-Accessible Base Unit Embodiment

This embodiment of a web-accessible base unit 200j is shown in FIG. 24.

The web-accessible base unit 200j includes the architecture, components, operation, and functionality of a standalone base unit embodiment 200e, together with an ethernet network interface for communication with a gateway device 160.

The gateway device 160 has a cellular modem for connection to a remote network server 110 and an ethernet port for connection to multiple web-accessible base units 200j via a standard ethernet hub. In this way, multiple web-accessible base units 200j can communicate with a remote network server 110.

### B.6.3 Alternative Web-Accessible Base Unit Embodiments

Alternative embodiments of the web-accessible base unit includes the architecture, components, operation, and functionality of any standalone base unit embodiment, together with any WAN network interface for communication with a remote network server via a WAN network.

Alternative embodiments of the web-accessible base unit includes the architecture, components, operation, and functionality of any standalone base unit embodiment, together with LAN network interface for connection to a gateway device.

Alternative embodiments of the gateway device implement a gateway suitable for any WAN network.

Alternative embodiments of the web-accessible base unit distribute functionality to the network server, such as a base unit that does not include a user interface and instead requires end-user programming of the base unit via a website.

Alternative embodiments of the web-accessible base unit communicate with an alert-extension using powerline communication, an RF network, or ethernet network.

The skilled reader will appreciate that each embodiment of a web-accessible base unit provides just one example of a multitude of suitable configurations and operational methods for hardware, firmware, and software, and that various changes, omissions, modifications, and additions may be made to each embodiment without departing from the scope of the invention.

### B.7 Thin-Client Base Unit

### B.7.1 First Thin-Client Base Unit Embodiment

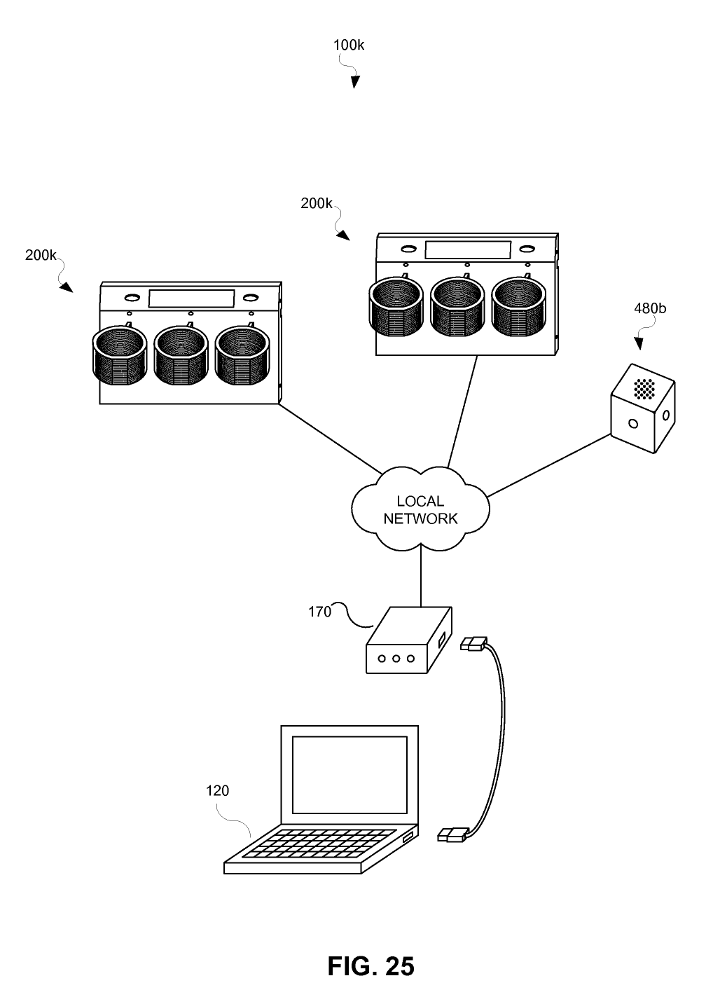

This embodiment of a thin-client base unit 200k is shown in FIG. 25.

The thin-client base unit 200k includes a scaled down version of the architecture, components, operation, and functionality of a standalone base unit embodiment 200e, together with an ethernet network interface for communication with a coordinator 170. The thin-client base unit 200k: (a) does not store a medication schedule, (b) does not implement time-keeping, (c) does not provide a user interface for input of a medication schedule or association of tracing modules with a medication type, (d) does not power tracked medication units, and instead interfaces with tagged medication units, (e) receives power through a power-over-ethernet (PoE) interface, and (f) does not communicate directly with alert-extensions 480ab.

The coordinator 170, discussed in a later section, implements much of the functionality removed from the thin-client base unit 200k.

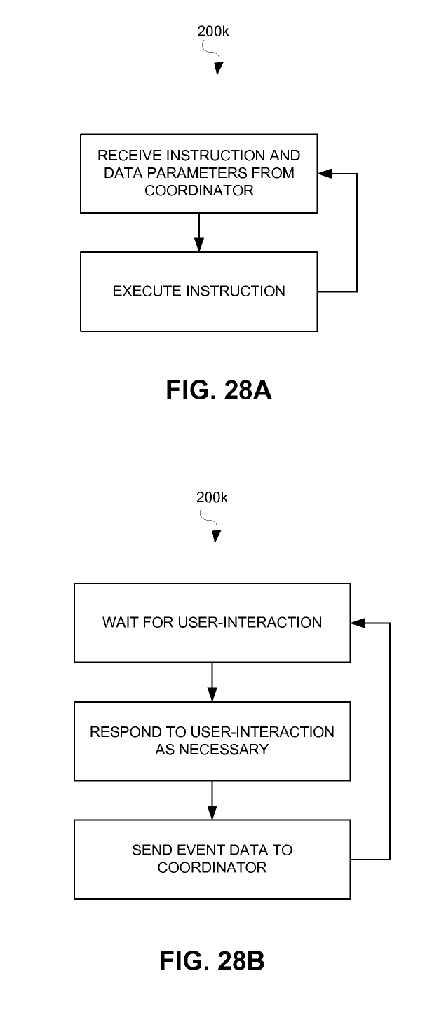

The thin-client base unit 200k operates as described in FIGS. 28A & 28B. Upon receiving an instruction and any associated data parameters from a coordinator 170, the thin-client base unit 200k promptly executes the instruction. As one example, the instruction is ‘turn-alert-on’ and the associated data parameters are the: message content for display, sound selection, volume level, snooze option, and visual indicator action. Upon a user's interaction (event) with the thin-client base unit 200k, such as the undocking of a tracked medication unit during an emitting alert, the thin-client base unit 200k cancels its alert and then sends the event data to the coordinator 170. If necessary, the coordinator 170 uses the event data to cancel all instances of the same alert emitting on alert-extensions 480b.

Thin-client base units are later referred to as thin-client devices.

### B.7.2 Alternative Thin-Client Base Unit Embodiments

Alternative embodiments of the thin-client base unit includes a scaled down version of the architecture, components, operation, and functionality of any standalone base unit embodiment, together with an ethernet network interface for communication with a coordinator 170.

Alternative embodiments of the thin-client base unit distribute functionality to a coordinator to varying degrees. As one example, a thin-client base unit implements the full-functionality of a standalone base unit embodiment 200e, except that the thin-client base unit does not implement an onboard user interface for input of a medication schedule or association of tracing modules, and instead receives power, medication schedules, dosages, usage directions, alert-options, and configuration settings through a PoE interface with a coordinator.

Alternative embodiments of the thin-client base unit communicate directly with alert-extensions via the PoE network, with the coordinator serving as a relay for such communications.

Alternative embodiments of the thin-client base unit include RTC components for keeping track of time locally. Occasional time updates from a coordinator are used to maintain long-term accuracy.

Alternative embodiments of the thin-client base unit implement any type of network interface with a coordinator, including powerline communication (PLC), wireless mesh, USB, Bluetooth, RF, Wireless USB, RS232, RS485, and so forth.

The skilled reader will appreciate that the each of the embodiments of a thin-client base unit provide just one example of a multitude of suitable hardware/firmware/software, connections, configurations, and operational methods, and that various changes, omissions, modifications, and additions may be made to each embodiment without departing from the scope of the invention.

### B.8 Base Unit Extension

Base unit extensions provide a way to expand the number of docking interfaces available for tracked medication units.

### B.8.1 First-Sixth Base Unit Extension Embodiments

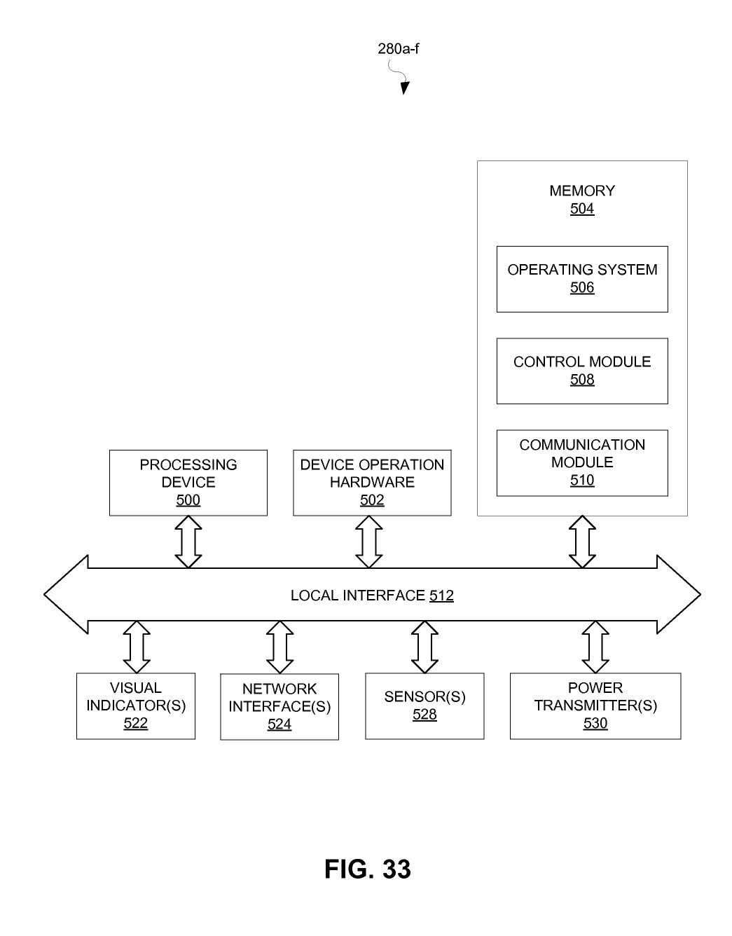

Base unit extension embodiments 280a-f have the architecture shown in FIG. 33, and the physical configurations shown in FIGS. 15A, 15B, 16A, 16B, 17A, 17B, 18A, 18B, 19A, 19B, & 20.

The processing device 500 is adapted to execute commands stored in memory 504 and comprises a general-purpose processor, a micro-processor, one or more application specific integrated circuits (ASICs), a plurality of suitably configured digital logic gates, and other known electrical configurations comprising discrete elements both individually and in various combinations to coordinate the overall operation of the base unit extension 280a-f.

The device operation hardware 502 comprises the various components used for the operation of the base unit extension 280a-f. The local interface 512 comprises the electrical interconnections between the components.

The memory 504 includes an operating system 506, a control module 508, and a communication module 510. The operating system 506 contains the various commands used to control the general operation of the base unit extension 280a-f. The communication module 510 comprises software or firmware that is adapted, in conjunction with the network interface 524 devices, to facilitate external communications. The control module 508 comprises the software/firmware which controls the operation of the base unit extension 280a-f.

Sockets 206 on either side of the base unit 200a-f and base unit extensions 280a-f, together with insert pins 208, provide a simple method for mechanically interlocking a base unit extension 280a-f to a base unit 200a-f.

The extension connector 212 and sidewall cutouts 210 on a base unit extension 280a-f have identical functionality to those on a corresponding base unit 200a-f.

LED indicators 204 on a base unit extension 280a-f have identical functionality to those on a corresponding base unit 200a-f.

Power transmitters 530 on a base unit extension 280a-f have identical functionality to those on a corresponding base unit 200a-f.

Sensors 528 on a base unit extension 280a-f have identical functionality to those on a corresponding base unit 200a-f.

One of the network interfaces 524 in the base unit extension 280a-f is a UART that facilitates RS232 communication with a connected base unit 200a-f. When a base unit extension 280a-f is connected to a base unit 200a-f, the base unit 200a-f detects the connection by monitoring the receive line of the UART, and communication is then initiated.

The remaining network interfaces 524 individually permit communication with a tracked medication unit at each docking interface, and have similar functionality to those on a corresponding base unit 200a-f.

The base unit extension 280a-f transparently connects each docked tracked medication unit to the base unit 200a-f, such that the base unit 200a-f equivalently controls all docked tracked medication units whether docked to a base unit extension 280a-f or the base unit 200a-f. When a base unit extension 280a-f is connected to the base unit 200a-f, the base unit 200a-f takes control of the added docking interfaces in addition to its own docking interfaces to effectively create a larger base unit. Discussion about the operation of the base unit 200a-f pertains equally to the larger base unit.

Although each base unit extension embodiment 280a-f generally seats the same tracked medication unit as its base unit 200a-f counterpart, this is not a requirement. For example, base unit extension 280e seats tracked medication unit 300j, whereas base unit 200e seats tracked medication unit 300i. In this way, flexibility of use of a medication management system 100 is enhanced.

### B.8.2 Alternative Base Unit Extension Embodiments

Alternative embodiments of base unit extensions are compatible with alternative embodiments of the base unit.

The skilled reader will appreciate that each embodiment of a base unit extension provides just one example of a multitude of suitable configurations and operational methods for hardware, firmware, and software, and that various changes, omissions, modifications, and additions may be made to each embodiment without departing from the scope of the invention.

### B.9 Alert-Extension

Alert-extensions provide a method for extending medication alerts to multiple areas of a building.

### B.9.1 General Description of the First-Second Alert-Extension Embodiments

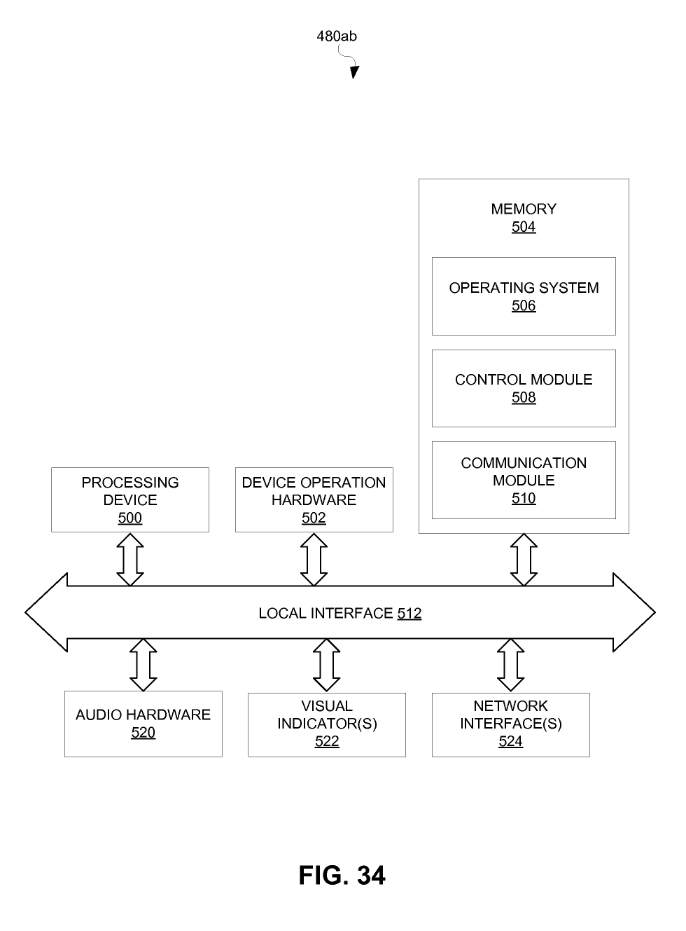

These embodiments of an alert-extension 480ab have the architecture shown in FIG. 34.

The processing device 500 is adapted to execute commands stored in memory 504 and comprises a general-purpose processor, a micro-processor, one or more application specific integrated circuits (ASICs), a plurality of suitably configured digital logic gates, and other known electrical configurations comprising discrete elements both individually and in various combinations to coordinate the overall operation of the alert-extension 480ab.

The device operation hardware 502 comprises the various components used for the operation of the alert-extension 480ab. The local interface 512 comprises the electrical interconnections between the components.

The memory 504 includes an operating system 506, a control module 508, and a communication module 510. The operating system 506 contains the various commands used to control the general operation of the alert-extension 480ab. The communication module 510 comprises software or firmware that is adapted, in conjunction with the network interface 524 device, to facilitate external communications. The control module 508 comprises the software/firmware which controls the operation of the alert-extension 480ab.

The visual indicators 522 and audio hardware 520 implement audio/visual alerts using LED indicators 486 and a speaker located just below the sound perforations 484.

### B.9.2 First Alert-Extension Embodiment

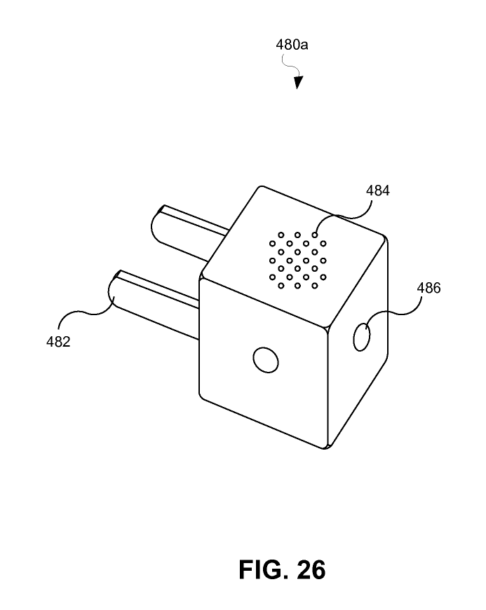

This embodiment of the alert-extension 480a has the physical configuration shown in FIG. 26.

The electrical prongs 482 facilitate plugging of an alert-extension 480a directly into an AC mains electrical outlet.

The alert-extension 480a contains an AC-DC switching power supply, a powerline communication coupler, and a powerline transceiver, in order to implement bidirectional communications with a powerline-enabled base unit, such as base unit 200e. In this way, a powerline-enabled base unit can control the issuance/cancellation of alerts on all connected alert-extensions 480a. The alert-extension 480a does not provide a user interface for cancellation of an alert. Alerts are cancelled through user acknowledgment of an alert at a base unit or base unit extension.

Alert-extension 480a is later referred to as a thin-client device.

### B.9.3 Second Alert-Extension Embodiment

The network interface of this alert-extension 480b embodiment is a PoE ethernet controller. Electrical prongs are not implemented on this embodiment, and power is instead supplied through the PoE interface. The alert-extension 480b can communicate with an ethernet-enabled base unit, such as a thin-client base unit.

The alert-extension 480b does not provide a user interface for cancellation of an alert. Alerts are cancelled through user acknowledgment of an alert at a base unit or base unit extension.

Alert-extension 480b is later referred to as a thin-client device.

### B.9.4 Alternative Alert-Extension Embodiments

Alternative embodiments of the alert-extension 480b include user-input methods such as a touch-sensitive casing, or button, for snooze/cancellation of an emitting alert.

Alternative embodiments of the alert-extension communicate with a base unit via an RF network.

The skilled reader will appreciate that each embodiment of an alert-extension provides just one example of a multitude of suitable configurations and operational methods for hardware, firmware, and software, and that various changes, omissions, modifications, and additions may be made to each embodiment without departing from the scope of the invention.

### B.10 Coordinator

The coordinator 170 facilitates the operations of all connected thin-client devices, such as thin-client base units 200k and alert-extensions 480ab.

### B.10.1 First Coordinator Embodiment

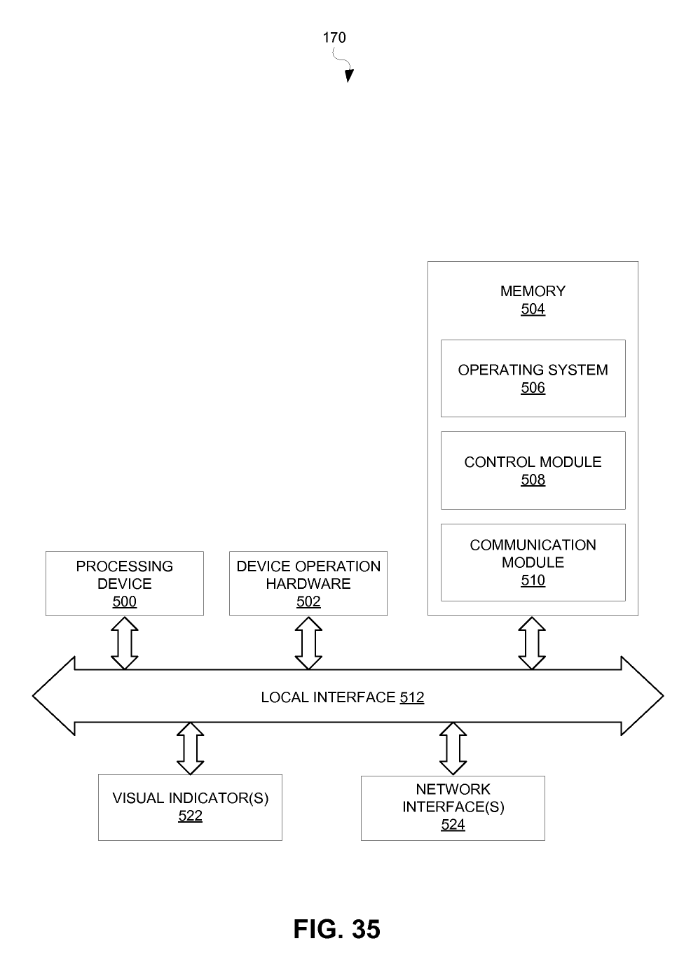

The coordinator 170 has the architecture shown in FIG. 35, and the physical configuration shown in FIG. 25.

The processing device 500 is adapted to execute commands stored in memory 504 and comprises a general-purpose processor, a micro-processor, one or more application specific integrated circuits (ASICs), a plurality of suitably configured digital logic gates, and other known electrical configurations comprising discrete elements both individually and in various combinations to coordinate the overall operation of the coordinator 170.

The device operation hardware comprises the various components used to operate the coordinator 170 including real-time clock (RTC) and power regulation circuitry. The local interface 512 comprises the electrical interconnections between the components.

The memory 504 includes an operating system 506, a control module 508, and a communication module 510. The operating system 506 contains the various commands used to control the general operation of the coordinator 170. The communication module 510 comprises software or firmware that is adapted, in conjunction with the network interface 524 devices, to facilitate external communications. The control module 508 comprises the software/firmware which controls the operation of the coordinator 170.

LED indicators provide status information such as base unit connectivity and network status.

A first network interface is a PoE ethernet controller for connection to one or more PoE-enabled thin-client devices via a PoE hub. A second network interface device is a USB interface for communication with a custom software application running on a local computing device 120. The custom software application implements a user interface accessible across multiple computers if the local computing device 120 is part of an intranet. The custom software application can guide an end-user through the following steps: (a) associating a medication type with the unique ID of a tagged medication unit (b) programming medication schedules, dosages, usage directions, and alert-options into a thin-client base unit, and (c) entering configuration settings for a thin-client device.

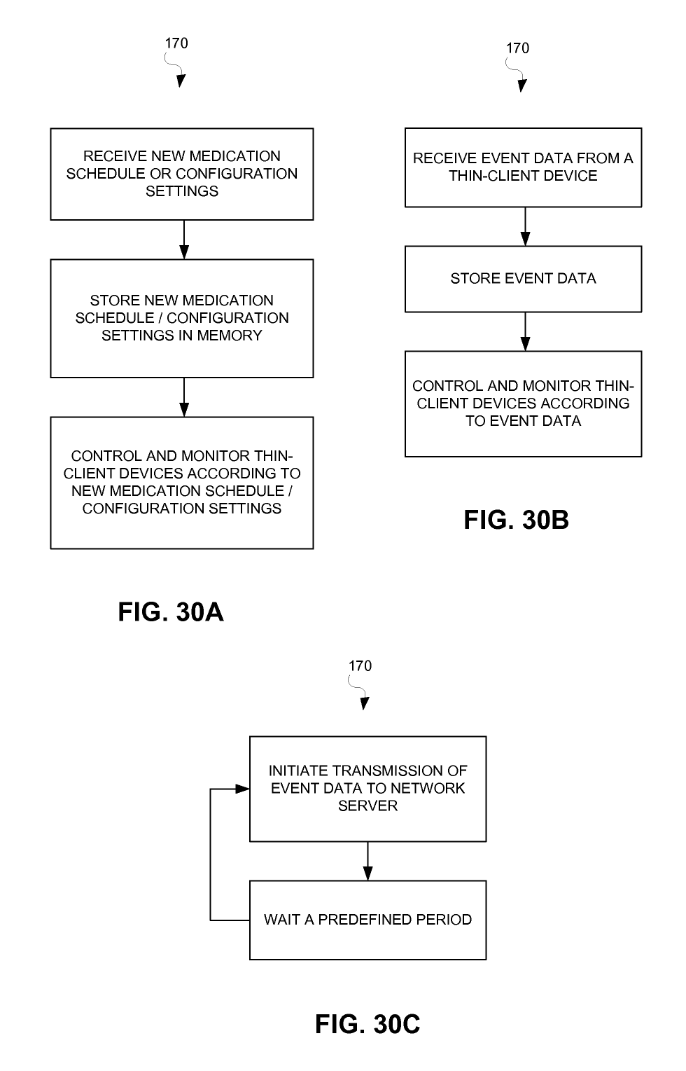

The operation of the coordinator 170 includes the steps shown in FIGS. 30A, 30B, & 30C. Upon receiving a medication schedule and/or configuration settings from the local computing device 120, the coordinator 170 stores the received data, and controls connected thin-client devices according to the new data. Other data that may be received from the local computing device 120 includes software/firmware updates or audio data. Upon receiving event data from a thin-client device, the coordinator 170 stores the event data, uses it to control/synchronize the operation of connected thin-client devices, and periodically (or as needed) transmits the event data to the local computing device 120. As one example, if a user cancels an alert emitting on one thin-client device, upon receipt of event data indicating that the alert was user-cancelled, the coordinator 170 cancels all instances of the same alert on other thin-client devices (such as alert-extensions 480ab).

Other event data transmitted by a coordinator 170 to a local computing device 120 includes the disconnected or connected status of thin-client devices.

The coordinator 170 uses onboard RTC circuitry to check the medication schedule each minute to determine if an alert/action is due. If so, the coordinator 170 transmits an instruction together with any data parameters necessary for execution by one or more thin-client devices. However, in the case of large data parameters, for example a ringtone or multimedia message, such data is transmitted separately and in advance to thin-client devices. Alternatively, data parameters can be permanently stored on the local computing device 120, and referenced by the coordinator 170.

The coordinator 170 also uses the onboard RTC circuitry to transmit a time update instruction with date/time data parameters to thin-client devices at one-minute intervals.

### B.10.2 Alternative Coordinator Embodiment

Alternative embodiments of the coordinator include any type/combination of network interface devices for connection to a computing device and thin-client devices. As one example, the coordinator may contain a single network interface device, such as an IEEE 802.11 interface, that permits the coordinator to communicate with a local computing device and thin-client devices. As another example, the coordinator may contain a cellular modem for connection to a network server and a PoE controller for communication with thin-client devices. Embodiments of the network interface devices may also include interfaces such as: PLC, wireless mesh, USB, Firewire, Bluetooth, RF, Wireless USB, RS232, RS485, and so forth.

Alternative embodiments of a coordinator include a coordinator and thin-client combined, resulting in numerous options for additional functionalities on the coordinator.

Alternative embodiments of the coordinator include a coordinator with an ethernet interface for connection to a computing device and an embedded web-server configured to generate web pages for entry of medication schedules and configuration settings.

The skilled reader will appreciate that the each of the embodiments of a coordinator provide just one example of a multitude of suitable hardware/firmware/software configurations, connections, operational methods, and security methods, and that various changes, omissions, modifications, and additions may be made to each embodiment without departing from the scope of the invention.

### B.11 Network Server

The network server includes hardware components such as: processor, motherboard, power supply, memory, hard drive, network interface, IO port, and/or any other suitable network server hardware components. The network server includes software components such as: Windows server operating system, Internet Information Services (IIS) web-server, Microsoft SQL server, ASP.NET web application, and Microsoft SQL database; or Linux server operating system, Apache web-server, PHP web application, and Oracle database; or any combination of the aforementioned, and/or any other suitable network server software components.

### B.11.1 First Network Server Embodiment

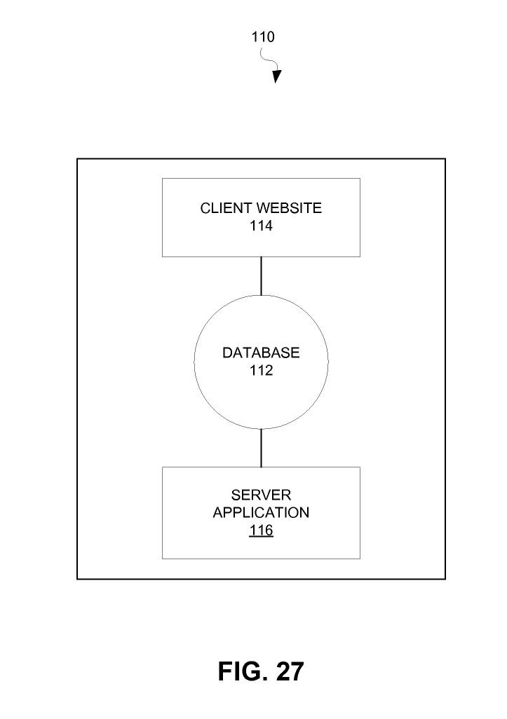

This embodiment of a network server 110, shown in FIG. 27, hosts a client website 114, server application 116, and database 112. The client website 114 is a secure portal for client access to a web-accessible base unit. The server application 116 bidirectionally communicates with a web-accessible base unit via a cellular network, and can communicate with mobile communication devices 130 via the Internet or cellular network. The client website 114 and the server application 116 operate independently, and interface through the database 112, which serves as a common data storage location.

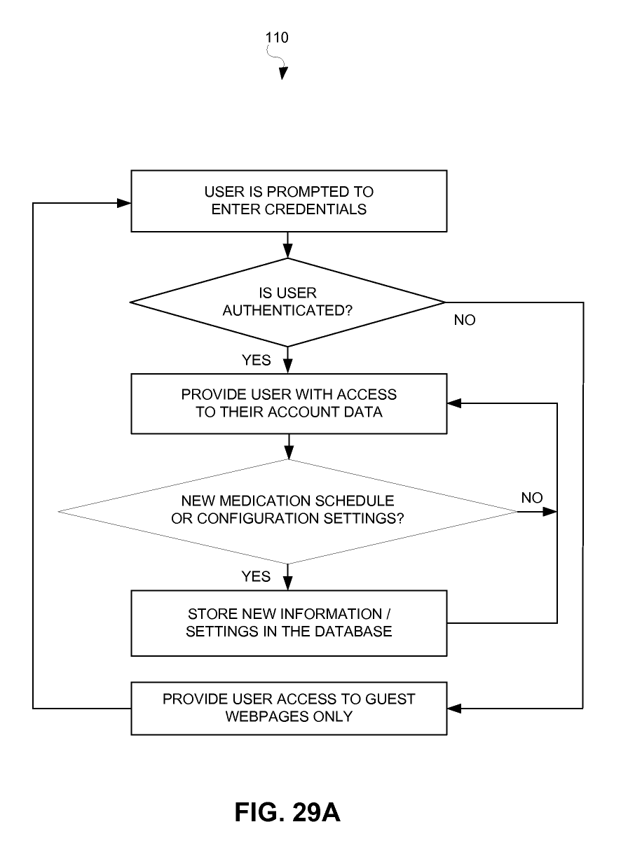

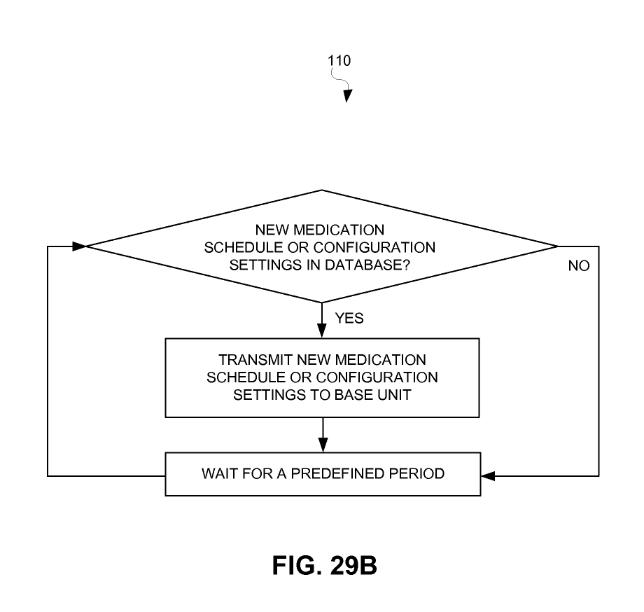

The operation of the client website 114 includes the steps shown in FIG. 29A. A client uses a web browser installed on a computing device 120 to initiate a connection with the client website 114 running on a network server 110. The credentials of the user of the computing device 120 must be authenticated by the client website 114 before further access to the client website 114 is granted. Upon authentication, the user can access user-account data, such as previously saved medication schedules, base unit and tracked medication unit configuration settings, and event data.

On the client website 114, the user can enter updated medication schedule information and/or configuration settings. The updated data is then stored in the database 112 prior to transmission to a remote device, such as a web-accessible base unit, gateway device 160, or coordinator 170.

The client website 114 also provides a user the option to send medication alerts to mobile communication devices 130 or computing devices 120 using communication methods such as SMS, MMS, email, page, or voice messages via the Internet or a cellular connection. A user can also specify criteria for triggering a message to a mobile communication device 130, such as an unacknowledged medication alert issuing on a base unit for over 30-minutes.

The client website 114 also provides a user with access to event data, such as a record of user-interactions with a web-accessible base unit and tracked medication units. The user may request reports which analyze and interpret event data. Such reports might be graphs, spreadsheets, and tables showing, for example, the history of a patient's acknowledgement of medication alerts.

The operation of the server application 116 includes the steps shown in FIG. 29B. Periodically, the server application 116 checks the database 112 for new medication schedule information, base unit configuration settings, and/or tracked medication unit configuration settings. If found, the server application 116 retrieves the new data from the database 112 and transmits it to the intended remote device.

The client website 114 is capable of hosting multiple user-accounts and communicating with multiple remote devices, mobile communication devices 130, and computing devices 120.

### B.11.2 Alternative Network Server Embodiments

Alternative embodiments of the network server may include a collection of network servers each implementing the complete functionality of the network server 110 as described in this disclosure, or parts of the complete functionality of the network server 110.

Alternative embodiments of a network server communicate with remote devices via the Internet.

The skilled reader will appreciate that each of the embodiments of a network server provide just one example of a multitude of suitable hardware/firmware/software configurations, connections, operational methods, and security methods, and that various changes, omissions, modifications, and additions may be made to each embodiment without departing from the scope of the invention.

### B.12 Medication Management System

The medication management system embodiments 100a-f provide: local configuration of medication alerts (and retrieval of event data).

The medication management system embodiments 100gh provide: (a) local configuration of medication alerts (and retrieval of event data), and (b) low-cost highly portable options for medication management.

The medication management system embodiment 100i provides: remote access for configuration of medication alerts (and retrieval of event data) on a single base unit.

The medication management system embodiment 100j provides: remote access for configuration of medication alerts (and retrieval of event data) on multiple base units.

The medication management system embodiment 100k provides: (a) building-wide access by a care-provider for configuration of medication alerts (and retrieval of event data) on multiple base units, (b) a high level of centralized control, and (c) low-cost/low-complexity base units.

### C. Conclusion

While particular embodiments have been described, it is understood that, after learning the teachings contained in this disclosure, modifications and generalizations will be apparent to those skilled in the art without departing from the spirit of the disclosed embodiments. It is noted that the foregoing embodiments and examples have been provided merely for the purpose of explanation and are in no way to be construed as limiting. While the system has been described with reference to various embodiments, it is understood that the words which have been used herein are words of description and illustration, rather than words of limitation. Further, although the system has been described herein with reference to particular means, materials and embodiments, the actual embodiments are not intended to be limited to the particulars disclosed herein; rather, the system extends to all functionally equivalent structures, methods and uses, such as are within the scope of the appended claims. Those skilled in the art, having the benefit of the teachings of this specification, may effect numerous modifications thereto and changes may be made without departing from the scope and spirit of the disclosed embodiments in its aspects.

The invention claimed is:

1) An electronically identifiable medication bottle, comprising:
a) a medication container; and
b) circuitry adapted for receipt and storage of power, transmission of identifying information, receipt of a medication schedule, and issuance of medication alerts, said circuitry includes a processor, a memory, a rechargeable power storage device, at least one audio or visual device, at least one network interface, and a user-interface,
whereby said circuitry can facilitate identification and administration of the contents of said medication container.

2) The electronically identifiable medication bottle of claim 1, wherein said circuitry adapted for receipt of power includes a power receiver coil for inductive coupling with an external device.

3) The electronically identifiable medication bottle of claim 2, wherein said at least one network interface includes a coil or antenna for communication via inductive coupling with an external device.

4) The electronically identifiable medication bottle of claim 3, wherein said at least one network interface further includes an NFC controller.

5) The electronically identifiable medication bottle of claim 4, wherein a portion of said circuitry is mounted on a flexible substrate in one or more sidewalls of said electronically identifiable medication bottle.

6) The electronically identifiable medication bottle of claim 5, wherein said circuitry adapted for receipt of power further includes an electrical connector with contacts for receipt of power from an external device.

7) The electronically identifiable medication bottle of claim 6, wherein said power receiver coil is located in one or more sidewalls of said electronically identifiable medication bottle.

8) The electronically identifiable medication bottle of claim 7, wherein said NFC controller is adapted to switch between peer-to-peer mode and card-emulation mode.

9) The electronically identifiable medication bottle of claim 8, wherein said electrical connector further includes contacts for communication with an external device.

10) The electronically identifiable medication bottle of claim 9, wherein said medication container is flexibly mounted within said electronically identifiable medication bottle, said user-interface includes a switch, and said medication container can twist relative to another portion of said electronically identifiable medication bottle such that said switch is actuated.

11) An electronically identifiable medication bottle, comprising:
a) a medication container; and
b) circuitry adapted for receipt and storage of power, transmission of identifying information, receipt of a medication schedule, and issuance of medication alerts, said circuitry includes a processor, a memory, a rechargeable power storage device, at least one audio or visual device, a USB interface, and a user-interface,
whereby said circuitry can facilitate identification and administration of the contents of said medication container.

12) The electronically identifiable medication bottle of claim 11, wherein said circuitry further includes a second USB interface, whereby two or more of said electronically identifiable medication bottles can be USB daisy-chained.

13) The electronically identifiable medication bottle of claim 12, wherein said circuitry further includes an NFC network interface for communication with an external NFC-enabled device.

14) The electronically identifiable medication bottle of claim 13, wherein a portion of said circuitry is mounted on a flexible substrate in one or more sidewalls of said electronically identifiable medication bottle.

15) The electronically identifiable medication bottle of claim 14, wherein said medication container includes a plurality of compartments for storage of medication, and said issuance of medication alerts includes an alert specific to each compartment.

16) The electronically identifiable medication bottle of claim 15, wherein said medication container further includes a rotatable disk with a cutout portion, said rotatable disk is mounted above said compartments, whereby said cutout portion permits selective access to one compartment at a time.

17) An electronically identifiable adapter, comprising:
a) an adapter for removable attachment to a medication container, said adapter including a base for seating a bottom portion of a medication container and a raised back for supporting a sidewall portion of a medication container; and
b) circuitry adapted for receipt and storage of power, transmission of identifying information, receipt of a medication schedule, and issuance of medication alerts, said circuitry includes a processor, a memory, a rechargeable power storage device, at least one audio or visual device, at least one network interface, and a user-interface,
whereby said circuitry can facilitate identification and administration of the contents of an attached medication container and a fastening mechanism can be used to removably attach a medication container to said electronically identifiable adapter.

18) The electronically identifiable adapter of claim 17, wherein said circuitry adapted for receipt of power includes an electrical connector with contacts for receipt of power from an external device.

19) The electronically identifiable adapter of claim 18, wherein said at least one network interface includes an NFC network interface for communication with an external NFC-enabled device.

20) The electronically identifiable adapter of claim 19, wherein said raised back further includes a rim for retention of an elastic band, tape, or strap in contact with said raised back.
